(19) United States
(12) Patent Application Publication
(10) Pub. No.: US 2025/0143852 A1
(43) Pub. Date: May 8, 2025

(54) METHOD, DEVICE, STORAGE MEDIUM, AND MEDICAL SYSTEM FOR GENERATING A RESTORATION DENTAL MODEL

(71) Applicant: SprintRay, Inc., Los Angeles (CA)

(72) Inventors: Yue Yang, Zhejiang (CN); Jiangtao Ran, Zhejiang (CN); Chuanbo Wang, Zhejiang (CN); Jiewei Li, Zhejiang (CN); Long Wang, Zhejiang (CN); Zeyun Yu, Zhejiang (CN); Zhiqiang Ran, Zhejiang (CN); Mark Lorich, Los Angeles, CA (US)

(21) Appl. No.: 18/939,000

(22) Filed: Nov. 6, 2024

(30) Foreign Application Priority Data
Nov. 8, 2023 (CN) CN202311486295.3

(51) Int. Cl. A61C 13/34; G06T 7/00; G06T 7/11

(52) U.S. Cl. CPC A61C 13/34; G06T 7/0012; G06T 7/11; G06T 2207/30036

(57) ABSTRACT

The present invention discloses a method, device, storage medium, and medical system for generating a restoration dental model. Among them, the method comprises: obtaining the restoration type of the tooth to be restored, wherein the restoration type includes at least one of the following: tooth implant type, crown restoration type, and inlay restoration type; determining the key points of the tooth to be restored based on the restoration type, where the key points of the tooth to be restored are used to represent the characteristics of the tooth to be restored; determining the restoration dental model based on the restoration type and the key points of the tooth to be restored. The present invention solves the technical problem of low efficiency of making restoration dental models artificially in related technologies.

### CROSS-REFERENCE TO RELATED APPLICATIONS

The present invention claims priority to CN patent Application No. 2023 1 1486295.3, filed Nov. 8, 2023, the content of which is hereby incorporated by reference in its entirety.

### TECHNICAL FIELD

The present invention involves the dental medicine field, specifically the method, device, storage medium, and medical system for generating the restoration dental model.

### BACKGROUND

In dental medicine field, especially in the dentistry field, dentists or dental experts need to generate a restoration dental model of the part of the tooth to be restored before performing dental restoration on patients. The generated restoration dental model can help dentists with preoperative planning. By observing the model, dentists can better understand the patient's oral condition, determine the shape, size, and position of the restoration, and develop a reasonable treatment plan.

At present, there are many dental restoration types, usually divided into implant restoration, crown restoration, inlay restoration, etc. Different restoration types correspond to different degrees of tooth defects. For example, implant restoration is often used to treat patients with significant tooth loss or complete absence of tooth, while crown restoration is generally used to treat single tooth with severe surface defects; Inlay restoration is generally used for local defects on the surface of a single tooth. Different tooth have unique and rich structural features on their surfaces, and different patients are also different. When dentists develop treatment plans for different patients and restoration types, they generally use silicone impression molds to roughly determine the structural characteristics of the tooth's local area based on feeling, observation, etc., and then manually adjust and try on multiple times to finally obtain a suitable restoration model. The treatment cycle is long, and the accuracy and efficiency of manual adjustment are low. For implant restoration, accuracy is the core of treatment. Once errors occur, the treatment effect will be greatly reduced or even fail, resulting in low efficiency in the current production of dental restoration models.

There is currently no effective solution proposed for the above-mentioned issues.

### BRIEF SUMMARY OF INVENTION

The embodiments of the present invention provide a method, device, storage medium, and medical system for generating a restoration dental model, to at least solve the technical problem of low efficiency in making restoration dental models in related technologies.

According to one aspect of the present invention, there is provided a method for generating a restoration dental model, including: obtaining a restoration type of a tooth to be restored, wherein the restoration type includes at least one of the following: dental implant type, crown restoration type, and inlay restoration type; determining key points of the tooth to be restored based on the restoration type, wherein the key points of the tooth to be restored are configured to represent the characteristics of the tooth to be restored; determining the restoration dental model based on the restoration type and the key points of the tooth to be restored.

Optionally, determining the restoration dental model based on the restoration type and the key points, including: obtaining a 3D oral image in response to the restoration type being the dental implant type; performing a tooth instance segmentation on the 3D oral image to obtain a tooth position region of a missing tooth; determining the key points of the dental implant based on the key points of the tooth to be restored; predicting the key points of the dental implant based on the tooth position region to obtain the restoration dental model, wherein the key points of the dental implant are configured to determine the implantation posture and size information of the dental implant.

Optionally, performing the tooth instance segmentation on the 3D oral image to obtain the tooth position region of the missing tooth in an oral cavity, including: constructing a 3D oral model based on the 3D oral image by using a model construction neural network model; performing the dental instance segmentation on the the 3D oral model by using an instance segmentation neural network model to obtain the tooth position region of the missing tooth in the oral cavity.

Optionally, constructing the 3D oral model based on the 3D oral image by using the model construction neural network model, including: dividing the 3D oral image to obtain multiple image blocks; sampling the multiple image blocks to obtain a target feature map; decoding the target feature map to obtain the 3D oral model.

Optionally, sampling the multiple image blocks to obtain the target feature map, including: downsampling the multiple image blocks to obtain multiple first feature maps; upsampling the multiple first feature maps to obtain multiple second feature maps, wherein the scales of the multiple second feature maps are different from the scales of the multiple first feature maps, and the scales between the multiple second feature maps are different; merging the multiple second feature maps and the multiple first feature maps to obtain the target feature map.

Optionally, decoding the target feature map to obtain the 3D oral model, including: decoding the target feature map to obtain an initial 3D oral model; deleting a target area in the initial 3D oral model, and/or reconstructing the disconnected neural conduit in the initial 3D oral model to obtain the 3D oral model, wherein the volume of the target area is less than a preset volume threshold.

Optionally, performing the dental instance segmentation on the the 3D oral model by using the instance segmentation neural network model to obtain the tooth position region of the missing tooth in the oral cavity, including: performing the dental instance segmentation on the 3D oral model by using the instance segmentation neural network model to obtain a dental model and a tooth number corresponding to the dental model; cropping the 3D oral model based on the dental model and the tooth number to obtain the tooth position region.

Optionally, performing the dental instance segmentation on the 3D oral model by using the instance neural network model to obtain the dental model and the tooth number corresponding to the dental model, including: performing the dental instance segmentation on the 3D oral model by using the instance neural network model to obtain the dental model and an initial tooth number corresponding to the dental model; in the case wherein there are multiple initial tooth numbers corresponding to the dental model, determining the tooth number with the largest proportion among the initial tooth numbers as the tooth number.

Optionally, cropping the 3D oral model based on the dental model and the tooth number to obtain the tooth position region, including: determining a target tooth position in the 3D oral model based on the dental model and the tooth number, wherein the target tooth position is a tooth position of the missing tooth; determining at least one adjacent dental model of the missing tooth based on the target tooth position; cropping the 3D oral model based on the at least one adjacent dental model to obtain the tooth position region.

Optionally, predicting the key points of the dental implant based on the tooth position region to obtain a prediction result, including: predicting the key points of the dental implant based on the tooth position region by using a key points prediction neural network model to obtain a key points heatmap, wherein the key points heatmap is configured to represent the key points of the dental implant by Gaussian distribution, and wherein the key points of the dental implant at least comprises the implant insertion point and the implant root tip point; determining the implantation posture and the size information of the dental implant based on the key points heatmap; generating the restoration dental model based on the implantation posture and the size information.

Optionally, obtaining the 3D oral image of a target object, including: obtaining multiple 2D oral images of the target object; performing 3D transformation on the multiple 2D oral images to obtain the 3D oral image.

Optionally, performing 3D transformation on the multiple 2D oral images to obtain the 3D oral image, including: performing 3D transformation on the multiple 2D oral images to obtain an initial 3D oral image; resampling multiple voxels in the initial 3D oral image to the same voxel spacing to obtain the 3D oral image.

Optionally, resampling the multiple voxels in the initial 3D oral image to the same voxel spacing to obtain the 3D oral image, including: resampling the multiple voxels in the initial 3D oral image to the same voxel spacing to obtain a target 3D oral image; cropping the interest region of the target 3D oral image to obtain a 3D oral image, wherein the interest region is configured to represent the area where the tooth of the target object are located.

Optionally, predicting the key points of the dental implant based on the tooth position region to obtain the restoration dental model, including: predicting the key points of the dental implant based on the tooth position region to obtain a prediction result; generating the restoration dental model in the 3D oral model based on the prediction result.

Optionally, determining the restoration dental model of the tooth to be restored based on the restoration type, including: obtaining a tooth number of the tooth to be restored and an outer contour of the restoration area of the tooth to be restored in response to the restoration type being the crown restoration type or the inlay restoration type, wherein the tooth to be restored is a dental model to be added with a restoration dental model, the tooth number is configured to represent the position information of the tooth to be restored in the dental model sequence, and the outer contour of the restoration area is the outer contour of a portion of a tooth body area in the tooth to be restored; determining a preset restoration dental model of the tooth to be restored based on the tooth number; deforming the preset restoration dental model to obtain the restoration dental model based on the key points of the tooth to be restored and the outer contour of the area to be restored.

Optionally, the method further including: determining an adjacent tooth number of an adjacent dental model based on the tooth number, wherein the adjacent dental model is the adjacent dental model of the tooth to be restored, and the adjacent tooth number is configured to represent the position information of the adjacent dental model in the dental model sequence; determining an adjacent tooth point cloud data of the adjacent dental model based on the adjacent tooth number; adjusting a gap between the restoration dental model and the adjacent dental model based on the adjacent tooth point cloud data.

Optionally, the method further including: determining an opposing dental model corresponding to the tooth to be restored, wherein the opposing dental model is a dental model that has an occlusal relationship with the tooth to be restored; determining an opposing tooth point cloud data of the opposing dental model based on a spatial position relationship between the tooth to be restored and the opposing dental model; adjusting the occlusion relationship between the restoration dental model and the opposing dental model based on the opposing tooth point cloud data.

Optionally, the method further including: displaying multiple candidate dental models on an operating interface in response to input instruction acting on the operation interface; displaying the tooth to be restored from the multiple candidate dental models on the operation interface in response to the confirmation instruction acting on the operation interface.

Optionally, the method further including: identifying the dental model sequence by using a deep learning model to obtain the tooth to be restored, wherein the deep learning model is obtained by training based on a sample dental model sequence and a sample tooth to be restored

Optionally, identifying the dental model sequence by using a deep learning model to obtain the tooth to be restored, including: performing an instance segmentation on the dental model sequence by using a dental segmentation model to obtaining multiple dental models; performing a classification on the multiple dental models by using a dental classification model to obtain the tooth to be restored.

Optionally, determining a preset virtual dental crown corresponding to the tooth to be restored based on the tooth number, including: retrieving the preset restoration dental model corresponding to the tooth to be restored from a preset database based on the tooth number, wherein the preset database comprises the preset restoration dental model corresponding to the different tooth number.

Optionally, determining the key points of the tooth to be restored, including: determining the key points of the tooth to be restored based on a tooth point cloud data and the tooth number of the tooth to be restored.

Optionally, determining the key points based on the tooth point cloud data of the tooth to be restored and the tooth number, including: determining the key points of the tooth to be restored based on the tooth point cloud data, the tooth number, and an adjacent tooth point cloud data of the tooth to be restored; or, determining the key points of the tooth to be restored based on the tooth point cloud data of the tooth to be restored, the tooth number, and an opposing tooth point cloud data; or, determining the key points of the tooth to be restored based on the tooth point cloud data, the tooth number, an adjacent tooth point cloud data, and an opposing tooth point cloud data of the tooth to be restored.

Optionally, determining the key points of the tooth to be restored, including: obtaining a tooth data of a symmetrical dental model of the tooth to be restored, wherein the symmetrical dental model is configured to represent a dental model that is symmetrical to the position of the tooth to be restored within a same row of teeth; determining the key points of the tooth to be restored based on the tooth data.

Optionally, the method further including: obtaining a dental model from a tooth collection and a scanning type of the dental model, wherein the dental model is a model obtained by scanning the tooth collection, and the tooth collection comprises at least one tooth; predicting the key points of the dental model based on the scanning type to obtain key points position of the dental model; marking the key points of the tooth collection in the dental model based on the scanning type and the key points position.

Optionally, the method further including: obtaining a tooth type of at least one tooth in the tooth collection in response to the scanning type being an image scanning type; calling a first deep learning model corresponding to the at least one tooth based on the tooth type; predicting the key points of the at least one tooth in the dental model by using the first deep learning model to obtain the key points position.

Optionally, predicting the key points of the at least one tooth in the dental model by using the first deep learning model to obtain the key points position, including: segmenting the dental model to obtain a target area corresponding to the at least one tooth; predicting the target area by using the first deep learning model to obtain the key points position.

Optionally, obtaining the tooth type of the at least one tooth in the tooth collection, including: determining a tooth type of the at least one tooth based on the tooth number of the at least one tooth.

Optionally, predicting the key points of the dental model based on the scanning type to obtain the key points position of the dental model, including: obtaining a 3D mesh model of the dental model in response to the scanning type being a CT scanning type; segmenting the 3D mesh model to obtain a single dental model of the at least one tooth; predicting the single dental model of the at least one tooth by using the second deep learning model to obtain the key points position.

Optionally, marking the key points of the tooth collection in the dental model based on the scanning type and the key points position, including: determining the key points of the tooth collection as a maxillofacial center point and a root tip point in response to the scanning type being a CT scanning type; marking the maxillofacial center point and the root tip point in the dental model based on the key points position.

Optionally, marking the key points of the tooth collection in the dental model based on the scanning type and the key points position, including: determining a key points type of the at least one tooth based on the tooth type of the at least one tooth in response to the scanning type being an image scanning type; marking the key points in the dental model based on the key points type and the key points position.

According to another aspect of the embodiments of the present invention, there is also provided a device for generating a restoration dental model, including: obtaining module, configured to obtain a restoration type of a tooth to be restored, wherein the restoration type comprises at least one of the following: dental implant type, crown restoration type, inlay restoration type; first determination module, configured to determine key points of the tooth to be restored based on the restoration type, wherein the key points of the tooth to be restored represent the characteristics of the tooth to be restored; second determination module, configured to determine a restoration dental model based on the restoration type and the key points of the tooth to be restored.

According to another aspect of the embodiments of the present invention, there is also provided a computer-readable storage medium, including: stored program, wherein the method for generating a restoration dental model is executed in the processor of the device controlled during the execution of the program.

According to another aspect of the embodiments of the present invention, there is also provided a medical system, including: one or more processors; storage device, configured to store one or more programs; when the one or more programs are executed by the one or more processors, causing the one or more processors to execute the method for generating restoration dental model.

In the embodiments of the present invention, obtaining a restoration type of a tooth to be restored, wherein the restoration type comprises at least one of the following: dental implant type, crown restoration type, and inlay restoration type; determining key points of the tooth to be restored based on the restoration type, wherein the key points of the tooth to be restored are configured to represent the characteristics of the tooth to be restored; determining the restoration dental model based on the restoration type and the key points of the tooth to be restored, which improves the generation efficiency of the restoration dental model. It is easy to note that the corresponding restoration method can be determined according to the restoration type of the tooth to be restored, and the restoration dental model of the tooth to be restored can be generated by combining the key points and restoration methods of the tooth to be restored. Compared with the traditional method of generating the restoration dental model manually, the restoration dental model generation method proposed in the above steps shortens the time for generating the tooth implant model. The technical solution proposed in The present invention improves the efficiency of restoration dental model generation in related technologies and solves the technical problem of low efficiency in making restoration dental models in related technologies.

### BRIEF DESCRIPTION OF THE DRAWING

The attached figures described here are intended to provide a further understanding of the present invention and form a part of it. The illustrative embodiments and their explanations of the present invention are used to explain the present invention and do not constitute an improper limitation of the present invention. In the attached figures:

FIG. 1 is a flowchart of a method for generating a restoration dental model according to an embodiment of the present invention;

FIG. 2 is a schematic diagram of the segmentation results of various anatomical structures in an optional CBCT image according to an embodiment of the present invention;

FIG. 3 is a schematic diagram of the heatmap prediction results of the root tip point of an optional CBCT image dental implant according to an embodiment of the present invention;

FIG. 4 is a schematic diagram of an optional root bone fusion and dental implant prediction effect according to an embodiment of the present invention;

FIG. 5 is a flowchart of an optional method for segmenting oral CBCT images and predicting the orientation of dental implants according to an embodiment of the present invention;

FIG. 6 is a schematic diagram of a 3D dental model of a prepared abutment tooth in an optional crown restoration according to an embodiment of the present invention;

FIG. 7 is a schematic diagram of a 3D dental model of the external surface of the crown obtained from an optional crown restoration according to an embodiment of the present invention;

FIG. 8 is a schematic diagram of a 3D dental model of the internal surface of the crown obtained from an optional crown restoration according to an embodiment of the present invention;

FIG. 9 is a schematic diagram of a 3D dental model with a crown installed on the abutment tooth in an optional crown restoration according to an embodiment of the present invention;

FIG. 10 is a schematic diagram which marks key points of the tooth collection in an oral scanner image of maxillary tooth according to an embodiment of the present invention;

FIG. 11 is a schematic diagram which marks key points of the tooth collection in an oral scanner image of mandibular tooth according to an embodiment of the present invention;

FIG. 12 is a schematic diagram which marks key points in a single dental model obtained by oral CT according to an embodiment of the present invention;

FIG. 13 is a schematic diagram of a 3D image of the upper incisor obtained by an oral scanner according to an embodiment of the present invention;

FIG. 14 is a schematic diagram of a 3D image of the lower incisor obtained by an oral scanner according to an embodiment of the present invention;

FIG. 15 is a schematic diagram of a 3D image of a premolar obtained by an oral scanner according to an embodiment of the present invention;

FIG. 16 is a schematic diagram of a 3D image of a molar obtained by an oral scanner according to an embodiment of the present invention;

FIG. 17 is a schematic diagram of the target area corresponding to the segmented upper incisor obtained according to an embodiment of the present invention;

FIG. 18 is a schematic diagram of the target area corresponding to the segmented lower incisor obtained according to an embodiment of the present invention;

FIG. 19 is a schematic diagram of the target area corresponding to a segmented premolar according to an embodiment of the present invention;

FIG. 20 is a schematic diagram of the target area corresponding to a segmented molar according to an embodiment of the present invention;

FIG. 21 is a schematic diagram of a device for generating the restoration dental model according to an embodiment of the present invention.

### DETAILED DESCRIPTION

In order to enable the skilled in the field to better understand the solution of the present invention, the following will provide a clear and complete description of the technical solution in the embodiments of the present invention in conjunction with the accompanying figures. Obviously, the described embodiments are only a part of the embodiments of the present invention, not all of them. Based on the embodiments of the present invention, all other embodiments obtained by ordinary skilled persons in this field without creative labor should fall within the scope of protection of the present invention.

It should be noted that the terms ‘first’, ‘second’, etc. in the specification and claims of the present invention and the attached figures are used to distinguish similar objects and do not necessarily need to be used to describe a specific order or sequence. It should be understood that the data used in this way can be interchanged in appropriate circumstances, so that the embodiments of the present invention described herein can be implemented in order other than those illustrated or described herein. In addition, the terms ‘comprising’ and ‘including’, as well as any variations thereof, are intended to cover non exclusive inclusions, such as processes, methods, systems, products, or devices that contain a series of steps or units that are not necessarily limited to those clearly listed, but may include other steps or units that are not clearly listed or inherent to these processes, methods, products, or devices.

### Embodiment 1

According to an embodiment of the present invention, a method for generating a restoration dental model is provided. It should be noted that the steps shown in the flowchart in the attached figures can be executed in a computer system such as a set of computer executable instructions, and although the logical sequence is shown in the flowchart, in some cases, the steps shown or described may be executed in a different order than here.

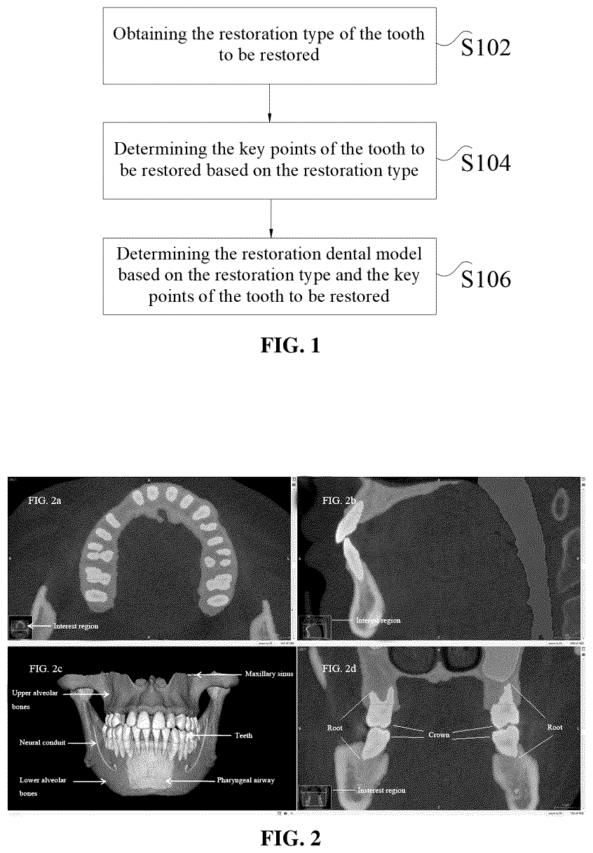

FIG. 1 shows a method for generating a restoration dental model according to an embodiment of the present invention. As shown in FIG. 1, the method comprises the following steps:

Step 102: Obtaining the restoration type of the tooth to be restored.

Among them, the restoration type includes at least one of the following: dental implant type, crown restoration type, and inlay restoration type.

The aforementioned implant dental type refers to the replacement of missing tooth by implanting tooth roots.

The aforementioned crown restoration type refers to repairing damaged tooth by the crown restoration.

The aforementioned inlay restoration type refers to the use of inlay restoration to repair partially damaged tooth.

In an optional embodiment, when determining the restoration type of the tooth to be restored, it is necessary to examine and evaluate the tooth to be restored, and determine the restoration type that needs to be performed. Common restoration type includes dental implant type, crown restoration type, and inlay restoration type.

In another optional embodiment, the restoration type of the tooth to be restored can be determined by considering factors such as the degree of damage to the tooth, the condition of the root, and the surrounding tissue. For example, when the damage to the tooth to be restored is minor, with only partial external wear or small cavities, crown restoration or inlay restoration can be chosen. However, when the damage to the tooth to be restored is severe, such as severe damaged or missing, dental implant can be chosen; When the root of the tooth is healthy and has sufficient gum support, crown restoration or inlay restoration can be chosen. When the root of the tooth has been lost or lacks sufficient support, dental implant can be considered; When the gum and bone tissue around the tooth are healthy, crown restoration or inlay restoration can be chosen, while when there is inflammation or bone loss in the tissues around the tooth, dental implant can be chosen.

In another optional embodiment, when determining whether the restoration type of the tooth to be restored is crown restoration or inlay restoration, factors such as the degree of damage to the tooth, the position of the tooth, and the condition of the tooth root can be comprehensively considered to further determine the restoration type of the tooth to be restored. For example, when only a small part of the tooth to be restored is damaged while the rest is still healthy, crown restoration can be chosen, while when many structures of the tooth to be restored are damaged, inlay restoration can be chosen; The type of tooth to be restored is also one of the factors affecting the choice of restoration method. For posterior tooth, including premolars and molars, due to the need for more chewing force, they are usually more suitable for inlay restoration. For incisor, including incisors and canines, due to their greater aesthetic appeal, they are more suitable for crown restoration; When there are serious problems with the root of a tooth, such as infection or apical lesions, crown restoration may be necessary to protect the pulp and root. However, if the root of the tooth is healthy but the tooth structure is damaged, then inlay restoration can be chosen to restore tooth function and appearance.

In another optional embodiment, when determining the restoration type of the tooth to be restored, professionals in the relevant field, including dentists or dental experts, are required to examine and evaluate the tooth to be restored by directly observing the user's tooth and combining it with a 3D oral image of the user's oral cavity, taking into account various factors mentioned above, in order to determine the restoration type of the tooth to be restored.

Step 104: Determining key points of the tooth to be restored based on the restoration type.

Among them, the key points of the tooth to be restored are configured to represent the characteristics of the tooth to be restored.

Determining the key points which needs attention during the restoration process based on different restoration types. For example, for dental implant type, key points may include the position of the gum line, the position and angle of the implant, etc; For the crown restoration type, key points may include the edge fit of the crown, the adaptation of the crown to the gums, etc; For inlay restoration type, key points may include the shape and size of the inlay, contact points with adjacent tooth, etc.

Step 106, determining the restoration dental model based on the restoration type and the key points of the tooth to be restored.

In an optional embodiment, the design of the restoration dental model can be determined based on the previously restoration type and key points. Depending on the different restoration type, different materials and techniques may be required to create restoration dental models. For example, for dental implant type, it may be necessary to use implants and crowns to form a restoration dental model; For crown restoration type, it may be necessary to use crown materials to create restoration dental models; For inlay restoration type, it may be necessary to use inlay materials and adjacent tooth to create a restoration dental model.

Through the above steps, obtaining the restoration type of the tooth to be restored first, wherein the restoration type includes at least one of the following: dental implant type, crown restoration type, and inlay restoration type. Then, determining the key points of the tooth to be restored based on the restoration type. Finally, determining the restoration dental model based on the restoration type and the key points of the tooth to be restored achieving the goal of determining the restoration dental model of the tooth to be restored according to different restoration types.

In the embodiments of the present invention, obtaining the restoration type of the tooth to be restored, wherein the restoration type includes at least one of the following: dental implant type, crown restoration type, and inlay restoration type; determining the key points of the tooth to be restored based on the restoration type, wherein the key points of the tooth to be restored are configured to represent the characteristics of the tooth to be restored; determining the restoration dental model based on the restoration type and the key points of the tooth to be restored, which improves the generation efficiency of the restoration dental model. It is easy to note that the corresponding restoration method can be determined according to the restoration type of the tooth to be restored, and the restoration dental model of the tooth to be restored can be generated by combining the key points and restoration methods of the tooth to be restored. Compared with the traditional method for generating the restoration dental model manually, the method for generating the restoration dental model proposed in the above steps shortens the time for generating the dental implant. The technical solution proposed in the present invention improves the efficiency of restoration dental model generation in related technologies and solves the technical problem of low efficiency in making restoration dental models in related technologies.

Optionally, determining the restoration dental model based on the restoration type and the key points, including: obtaining a 3D oral image in response to the restoration type being the dental implant type; performing a tooth instance segmentation on the 3D oral image to obtain a tooth position region of a missing tooth; determining the key points of the dental implant based on the key points of the tooth to be restored; predicting the key points of the dental implant based on the tooth position region to obtain the restoration dental model, wherein the key points of the dental implant are configured to determine the implantation posture and size information of the dental implant.

Among them, the dental implant to be embedded in the oral cavity of the target object.

The aforementioned target object refers to patients who need dental implants, with dental implants to be embedded in their oral cavity. Dental implant surgery is suitable for people with missing one or more tooth, loose tooth, and other conditions.

The aforementioned 3D oral image refers to image data obtained through Cone Beam Computed Tomography (CBCT). CBCT is a medical imaging technique that obtains high-quality 3D images by using a cone beam X-ray source and a planar detector. CBCT data typically includes 3D voxel data, 2D slice images, and reconstructed images.

In an optional embodiment, obtaining the 3D oral image of the target object can be achieved by first placing the target object within the scanning area of the CBCT device and ensuring theirs correct position and posture; Set the scanning parameters of the CBCT device based on the acquired images, such as scanning area, scanning time, and resolution, and start the CBCT device for scanning; Finally, the scanned 2D imaging data is reconstructed by using the computer software of the CBCT device to generate the 3D oral image.

The aforementioned tooth instance segmentation can be an image processing method aimed at segmenting tooth images from the 3D oral image and distinguishing them from other image contents in the 3D oral image. By preforming the tooth instance segmentation in the 3D oral image, dentists or dental experts can more accurately implant the tooth, providing important assistance for dentists or dental experts.

The aforementioned tooth position region can be the missing tooth region and the adjacent tooth region of the missing tooth, mainly used for locating and displaying the missing tooth and the surrounding area of the missing tooth.

In an optional embodiment, performing the tooth instance segmentation on the 3D oral image to obtain the tooth position region of the missing tooth. Deep learning methods can be used to perform tooth instance segmentation on the 3D oral image using a trained tooth segmentation network model, thereby obtaining the tooth position region of damaged tooth in the oral cavity. Among them, the tooth segmentation network model can be a deep learning model used for tooth instance segmentation of 3D oral images. The construction and training process of the tooth segmentation network model can first collect a certain number of 3D oral model datasets with missing tooth, label the tooth position regions of the missing tooth for the 3D oral model datasets, then select a neural network model which is suitable for the tooth instance segmentation task, train the selected neural network model by using the labeled 3D oral model datasets, and finally evaluate the model using a portion of the 3D oral model data that did not participate in the training.

The key points based on the tooth to be restored refers to the key points of the standard tooth at that position, the key points of the dental implant can be determined based on the key points of the standard tooth.

The aforementioned key points of the dental implant may include but is not limited to: gingival margin key points, tooth root key points, tooth center key points, alveolar bone key points, and tooth bite key points. Among them, the key points at the edge of the gums can refer to the contact point between the gums and tooth, which is used to check the health status of the gums; The key points at the root of a tooth can refer to the contact point between the tooth root and the alveolar bone, which is used to evaluate the stability of the tooth and the depth of the periodontal pocket; The key points at the center of a tooth can refer to the center point of the tooth, which is used to evaluate the position of the tooth and its impact on adjacent tooth; The key points of alveolar bone can refer to the critical area of alveolar bone, which is used to evaluate the health status and density of alveolar bone; The key points of tooth occlusion can refer to the key points of contact between tooth during occlusion, used to evaluate the occlusal relationship between tooth. By predicting these key points, dentists can more accurately determine the implantation posture and size information of the dental implant during dental implant surgery, improving the success rate and effectiveness of the surgery.

The aforementioned model of the dental implant can be a model used to display the structure and morphology of the tooth to be implanted by the user. The implant dental model can be used in the stomatologic field to provide a basis for the user's dental implant surgery.

In an optional embodiment, the key points of the dental implant can be predicted based on the tooth position region, which can be achieved by using image analysis and pattern recognition methods. A trained implant key points prediction model can be used to predict the key points of the dental implant based on the tooth position region. The implant key points prediction model can be a deep learning model used to predict the key points of the dental implant. The construction and training process of the implant key pointed prediction model can first collect a certain number of 3D oral model datasets of the dental implant, label the key points of the missing tooth for the 3D oral model datasets of the dental implant, and then select a neural network model which is suitable for the key points prediction task, Train the selected neural network model by using the marked 3D implant dental model datasets, and finally evaluate the implant key points prediction model by using a portion of the untrained 3D implant dental model data. It should be noted that other methods can also be used to predict the key points of the dental implants and there is no limitation here.

In an optional embodiment, the model of the dental implant can be obtained based on the predicted key points of the dental implant. This can be achieved by first processing and converting the predicted key points data of the dental implant, and then using Computer-Aided Design software (CAD) or other 3D modeling tools to draw the shape and structure of the dental implant based on the position and size of the key points, creating a dental implant model. Finally, texture and material can be added to the implant dental model based on the actual material and appearance characteristics of the dental implant, and parameters such as lighting, shadows, and reflections can be adjusted and optimized as needed to achieve rendering of the model. Among them, Computer-Aided Design software can be a tool and method that utilizes computer technology to assist in design, drawing, and simulation; A 3D modeling tool can be a software tool used for creating, editing, and rendering 3D models. It should be noted that other methods can also be used to obtain the implant dental model based on the key points of dental implants, and there is no limitation here.

In stomatology, especially in the field of dentistry, dentists or dental experts need to generate the patient's dental implant model before implanting tooth. Generating a dental implant model can help dentists or dental experts better plan preoperative procedures. Dentists or dental experts can use models to understand the patient's dental condition, determine the optimal implantation position and angle, and choose the appropriate implant size and shape.

At present, when generating dental implant models, it generally rely on manual production of implant dental models in relevant technologies, in order to facilitate preoperative planning of patients' dental implants based on the implant dental model. However, the efficiency of manual production of implant dental models is relatively low.

In the embodiments of the present invention, determining the restoration dental model of the tooth to be restored based on the restoration type, including: obtaining the 3D oral image of the target object in response to the restoration type being crown restoration or inlay restoration type, wherein the dental implant to be embedded in the oral cavity of the target object; Performing the tooth instance segmentation on the 3D oral image to obtain the tooth position region of the missing tooth in the oral cavity; Predicting the key points of the dental implant based on the tooth position region to obtain the implant dental model. Among them, the key points are used to determine the implantation posture and size information of the dental implant. It has achieved the generation of implant dental models based on 3D oral images of target object through computer technology. Compared to traditional methods that require manual production of implant dental models, the above steps propose the automatic generation of implant dental models through computers, which shortens the time required for implant dental model generation and improves the efficiency of implant dental model generation in related technologies, thereby solving the technical problem of low efficiency in manual production of implant dental models in related technologies.

Optionally, performing the tooth instance segmentation on the 3D oral image to obtain the tooth position region of the missing tooth in an oral cavity, including: constructing the 3D oral model based on the 3D oral image by using the model construction neural network model; performing the dental instance segmentation on the the 3D oral model by using the instance segmentation neural network model to obtain the tooth position region of the missing tooth in the oral cavity.

The aforementioned neural network model can be a computational model composed of an input layer, several hidden layers, and output layers. The input layer of the neural network model receives 3D oral image data, the hidden layer calculates and processes the 3D oral image data, and the output layer outputs the 3D oral model.

The aforementioned 3D oral model can be the oral structure model presented by using 3D technology. By observing and operating the 3D oral model, the complexity and anatomical relationships of the oral structure can be more intuitively understood, which is helpful for dentists to diagnose and formulate treatment plans for dental implant surgery.

The aforementioned instance segmentation neural network model can be a deep learning model used for segmenting target tooth in dental models. This model can accurately predict the boundaries and positions of tooth, thereby automatically identifying and segmenting each tooth in the image, providing assistance for medical diagnosis and treatment which are related with tooth.

In an optional embodiment, constructing the 3D oral model based on the 3D oral image by using the model construction neural network model. A certain number of 3D oral model datasets can be used as the training set, and the training set can be input into the neural network model for training. The model parameters are continuously adjusted to improve the accuracy and generalization ability of the model; Use the test set data again to test the trained model and evaluate the quality of the generated 3D oral model; Finally, the trained model is applied to real-world scenarios, input oral image data and generate a corresponding 3D oral model through a neural network model.

In an optional embodiment, performing the dental instance segmentation on the the 3D oral model by using the instance segmentation neural network model to obtain the tooth position region of the missing tooth in the oral cavity. This can be achieved by collecting a 3D oral model dataset with the missing tooth, labeling the missing tooth position regions for the 3D oral model dataset, selecting a neural network model which is suitable for the tooth instance segmentation task, training the selected neural network model by using the labeled 3D oral model dataset, evaluating the model using a portion of the untrained 3D oral model data, segmenting the new 3D oral model data by using the trained instance segmentation neural network model, and obtaining the tooth position region of the missing tooth in the oral cavity.

Optionally, constructing the 3D oral model based on the 3D oral image by using the model construction neural network model, including: dividing the 3D oral image to obtain multiple image blocks; sampling the multiple image blocks to obtain a target feature map; decoding the target feature map to obtain the 3D oral model.

The aforementioned image blocks refer to multiple uniform, non overlapping image blocks that are divided from the entire 3D oral image, each of which is a local area of the 3D oral image that can be used for further analysis, processing, or feature extraction. The purpose of dividing image blocks is to better analyze and diagnose oral images, so that doctors or computer algorithms can detect and recognize oral problems.

The aforementioned target feature map refers to the combination and integration of features extracted from each image block to obtain the target feature map. The target feature map can be used for analysis, diagnosis, and prediction of oral images. Through the analysis of the target feature map, it can help doctors or computer algorithms detect and recognize oral problems.

In an optional embodiment, dividing the 3D oral image to obtain multiple image blocks, which may include preprocessing the 3D oral image, selecting appropriate dividing methods, common dividing methods include fixed size dividing and dividing based on specific structures. According to the selected dividing method, the 3D oral image is divided, and the divided multiple image blocks are saved as separate image files. It should be noted that during the dividing process, the continuity and integrity between image blocks should be ensured to avoid information loss or overlap.

In an optional embodiment, sampling the multiple image blocks to obtain a target feature map. The sampling method can be random sampling or sampling according to certain rules. During the sampling process, some interesting features can be selected for extraction. For example, one can choose to extract texture features, shape features, or color features from image blocks, which can be extracted by calculating statistics, gradients, edges, etc. of the image blocks.

In an optional embodiment, decoding the target feature map to obtain the 3D oral model. The decoding process can be achieved through reverse operation. Firstly, based on the information in the target feature map, the features of each image block can be restored through the inverse operation of the feature extraction algorithm. Then, reconstruct the image blocks based on their positions in the original 3D oral image, a complete 3D oral model can be obtained. Finally, the reconstructed 3D oral model can be further analyzed, processed, and visualized.

Optionally, sampling the multiple image blocks to obtain the target feature map, including: downsampling the multiple image blocks to obtain multiple first feature maps; upsampling the multiple first feature maps to obtain multiple second feature maps, wherein the scales of the multiple second feature maps are different from the scales of the multiple first feature maps, and the scales between the multiple second feature maps are different; merging the multiple second feature maps and the multiple first feature maps to obtain the target feature map.

The aforementioned downsampling refers to reducing the resolution of image blocks, usually achieved by reducing the size of the image blocks or decreasing the number of pixels in the image blocks.

The aforementioned first feature map refers to the downsampling result of each first feature map corresponding to image blocks. The first feature map can reflect the overall features of the image blocks, and these first feature maps can be used for further analysis and processing.

The aforementioned upsampling refers to increasing the resolution of an image, usually achieved by enlarging the size of the image or increasing the number of pixels in the image.

The aforementioned second feature maps refers to the upsampling results of each second feature map corresponding to the first feature map. The second feature maps contain more details and local features, which can be used for further analysis and processing.

In an optional embodiment, downsampling the multiple image blocks to obtain multiple first feature maps. During the downsampling process, different sampling methods can be used, such as average pooling, max pooling, etc. These methods can compress and extract the information of the image blocks to obtain their main features. Upsampling the multiple first feature maps to obtain multiple second feature maps. During the upsampling process, different interpolation methods can be used, such as nearest neighbor interpolation, bilinear interpolation, etc. These methods can add and fill the image at the pixel level to restore the details and information of the image block. Merging the multiple second feature maps and the multiple first feature maps to obtain the target feature map. During the merging process, different methods can be used, such as feature map concatenation, weighted summation, etc. The specific method can be selected according to specific tasks and requirements. The purpose of merging features is to fuse features of different levels and scales to obtain more global and comprehensive information.

Optionally, decoding the target feature map to obtain the 3D oral model, including: decoding the target feature map to obtain an initial 3D oral model; deleting a target area in the initial 3D oral model, and/or reconstructing the disconnected neural conduit in the initial 3D oral model to obtain the 3D oral model, wherein the volume of the target area is less than a preset volume threshold.

The aforementioned neural conduit refers to the nerve channel existing inside the mandible, which is mainly passed through by the mandibular nerve. In oral implant surgery, it is necessary to understand the position and direction of the neural conduit to avoid damaging the mandibular nerve during surgery, which may have adverse effects on the patient's sensory and motor functions.

In an optional embodiment, the target feature map can be decoded to obtain the initial 3D oral model. The decoding process can be achieved through reverse operation. Firstly, based on the information in the target feature map, the feature representation of each image block can be restored through the reverse operation of the feature decoding algorithm. Then, by reconstructing the image blocks based on their positions in the original 3D oral image, the initial 3D oral model can be obtained. Finally, the initial 3D oral model can be further processed and optimized.

In an optional embodiment, the target area in the initial 3D oral model can be deleted, and editing software or tools for the 3D oral model can be used to delete the selected target area in the initial 3D oral model. Deleting these areas can simplify the model and make it easier to process and analyze.

In another optional embodiment, the disconnected neural conduit in the initial 3D oral model can be reconstructed to obtain a 3D oral model. Software tools can be used to segment the neural conduit area in the 3D oral model. Based on the segmented neural conduit area, 3D modeling software can be used to reconstruct the disconnected neural conduit. Reconstructing the disconnected neural conduit can help doctors accurately locate the nerve position, avoid nerve injury, and reduce surgical risks and complications.

In another optional embodiment, the target area in the initial 3D oral model can be deleted, and the disconnected neural conduits in the initial 3D oral model can be reconstructed to obtain a 3D oral model. The deletion tool in the 3D modeling software can be used to delete the selected target area from the initial oral model, and then the modeling tool in the 3D modeling software can be used to recreate the disconnected neural conduits. By deleting unnecessary areas, the initial 3D oral model can be simplified, improving the efficiency of subsequent analysis. Reconstructing the disconnected neural conduits can restore the integrity of the initial 3D oral model and help to more accurately study and analyze the neural activity inside the oral cavity, resulting in a more accurate 3D oral model. FIG. 2 is a schematic diagram of the segmentation results of various anatomical structures in an optional CBCT image based on an embodiment of the present invention. As shown in FIG. 2c, it shows the segmentation and mesh reconstruction results of the upper and lower alveolar bones, maxillary sinus, neural conduit, and pharyngeal airway in various dimensions. The upper alveolar bone and maxillary sinus are bounded by the horizontal plane of the condyle, and the regions of each tissue structure are clearly visible.

Optionally, performing the dental instance segmentation on the the 3D oral model by using the instance segmentation neural network model to obtain the tooth position region of the missing tooth in the oral cavity, including: performing the dental instance segmentation on the 3D oral model by using the instance segmentation neural network model to obtain a dental model and a tooth number corresponding to the dental model; cropping the 3D oral model based on the dental model and the tooth number to obtain the tooth position region.

The aforementioned tooth number can be a marking system used to describe and distinguish different tooth, which may vary in different countries and regions. Each tooth has a unique tooth number for diagnosing and recording oral problems, helping dentists and oral physicians accurately describe and locate specific tooth.

In an optional embodiment, the international dental position method can be used as an example to divide the oral cavity into four quadrants, each quadrant having eight tooth numbers, starting from the incisor (central incisor) and numbered counterclockwise. The tooth in the upper right quadrant are numbered 1-8, the lower right quadrant is numbered 9-16, the lower left quadrant is numbered 17-24, and the upper left quadrant is numbered 25-32. This is only an example, and it should be noted that different tooth number systems may have different coding rules and labeling methods.

In an optional embodiment, perform tooth instance segmentation on the 3D oral model by using instance segmentation neural network model, obtaining the dental model and the corresponding tooth number. This can be achieved by using a trained instance segmentation neural network model to segment the 3D oral model into tooth instances and obtain the segmented dental model; Finally, preprocessing operations such as noise removal and image smoothing are performed on the segmented dental model to extract the contours of each tooth. Using the shape and features of the extracted tooth contours, combined with the characteristics of different tooth, the corresponding tooth number of the segmented dental model is identified and obtained. As shown in FIG. 2, Figure d, the segmentation results of the 3D oral model instance of tooth are presented. It can be seen that the morphology from the crown to the root tip is complete, the tooth number is correct, and the mesh surface is relatively smooth.

In an optional embodiment, the 3D oral model is cropped based on the dental model and tooth number to obtain the tooth position region. This can be achieved by importing the dental model and corresponding tooth number into the software of the oral 3D model, determining the tooth position region to be cropped as needed, using the cutting tool of the oral 3D model software, performing cutting operations according to the tooth position region to be cropped, checking the cropped oral model, and ensuring the accuracy of the cutting area. The oral 3D model software can be a software tool for creating, editing, and visualizing oral structures, usually including editing operations such as moving, rotating, scaling, and cutting the oral 3D model.

Optionally, performing the dental instance segmentation on the 3D oral model by using the instance neural network model to obtain the dental model and the tooth number corresponding to the dental model, including: performing the dental instance segmentation on the 3D oral model by using the instance neural network model to obtain the dental model and an initial tooth number corresponding to the dental model; in the case wherein there are multiple initial tooth numbers corresponding to the dental model, determining the tooth number with the largest proportion among the initial tooth numbers as the tooth number.

In an optional embodiment, perform tooth instance segmentation on the 3D oral model by using instance segmentation neural network model, obtaining the dental model and the initial tooth number corresponding to the dental model. This can be achieved by using a trained instance segmentation neural network model to segment the 3D oral cavity model into tooth instances and obtain the segmented dental model; Finally, preprocessing operations such as noise removal and image smoothing are performed on the segmented dental model to extract the contours of each tooth. Using the shape and features of the extracted tooth contours, combined with the characteristics of different tooth, the initial tooth number corresponding to the segmented dental model is identified and obtained.

In an optional embodiment, when the number of initial tooth numbers corresponding to the dental model is multiple, the tooth number with the largest proportion in the initial tooth numbers is determined as the tooth number. This can be achieved by first counting the number of each tooth number in the dental model, then calculating the proportion of each tooth number, that is, dividing the number of tooth of that tooth number by the sum of all tooth, and finally finding the tooth number with the largest proportion in terms of quantity, that is, the tooth number with the largest proportion in terms of quantity.

Optionally, cropping the 3D oral model based on the dental model and the tooth number to obtain the tooth position region, comprising: determining a target tooth position in the 3D oral model based on the dental model and the tooth number, wherein the target tooth position is a tooth position of the missing tooth; determining at least one adjacent dental model of the missing tooth based on the target tooth position; cropping the 3D oral model based on the at least one adjacent dental model to obtain the tooth position region.

The aforementioned target tooth position can be the position information of the missing tooth, that is, the tooth to be restored in the dental model. The position of the target tooth can be located in the dental model based on the tooth number system. It should be noted that different tooth number systems may have different encoding rules and annotation methods.

In an optional embodiment, the target tooth position in the 3D oral model is determined based on the dental model and tooth number. This can be done by determining the target tooth position corresponding to the tooth number based on the tooth number system on the dental model. For example, if the tooth number is determined to be #1, then the target tooth position is determined to be the first upper right incisor; Based on the target tooth position, at least one adjacent dental model of the missing tooth can be determined by examining the tooth near the target tooth position in the dental model. For example, if the target tooth position is tooth #1 (upper right first incisor), the adjacent tooth of that tooth position can be the upper right second incisor (tooth #2) or the upper right first premolar (tooth #3), and at least one adjacent dental model can be selected; Based on at least one adjacent dental model, the 3D oral model is cropped to obtain the tooth position region. The adjacent dental model can be aligned with the 3D oral model, and corresponding cropping and trimming can be performed according to the position and size of the adjacent tooth to obtain the tooth position region of the target tooth position.

Optionally, predicting the key points of the dental implant based on the tooth position region to obtain a prediction result, including: predicting the key points of the dental implant based on the tooth position region by using a key points prediction neural network model to obtain a key points heatmap, wherein the key points heatmap is configured to represent the key points of the dental implant by Gaussian distribution, and wherein the key points of the dental implant at least comprises the implant insertion point and the implant root tip point; determining the implantation posture and the size information of the dental implant based on the key points heatmap; generating the restoration dental model based on the implantation posture and the size information.

The aforementioned key points prediction neural network model can be a deep learning model used for predicting key points of dental implants. The aforementioned neural network model can be composed of an input layer, several hidden layers, and an output layer. The input layer receives 3D oral image of the tooth position region to be restored, the hidden layer calculates and processes the 3D oral image of the tooth position region to be restored, and the output layer outputs key points heatmap. The construction and training process of the neural network model can be to first collect a certain number of image data of dental implants in the tooth position region, with labeled key points of the dental implants on each image, and then use the labeled images and corresponding key points data to train the neural network model.

The aforementioned key points heatmap can be a visual representation method that highlights the importance of key points by highlighting the pixel values around their positions on the tooth. This key points heatmap represents key points through Gaussian distribution, which has a smooth characteristic. By applying Gaussian weights around the key points, the heatmap can present a smooth transition effect, which is very helpful for visual representation and analysis. It can reduce the influence of noise and abrupt points, making the heatmap more readable; And Gaussian distribution can assign weights to pixels around key points, so that high-value areas in the heatmap will accurately indicate the location of key points, rather than just isolated points. This enhances the spatial correlation between the heatmap and the original image, making it easier for observers to understand the distribution of key points.

In an optional embodiment, a key points prediction neural network model is used to predict the key points of a dental implant based on the tooth position region, and a key points heatmap is obtained. This can be achieved by using a trained key points prediction neural network model to predict the position of the key points of the dental implant based on the tooth position region image of the tooth to be restored, and generating a key points heatmap. FIG. 3 is a schematic diagram of the prediction result of an optional CBCT image of the root tip heatmap of the dental implant according to an embodiment of the present invention. As shown in FIG. 3, the input image of the key points prediction neural network model and the resulting implant and root tip heatmap are displayed. FIG. 3 shows the sagittal plane from left to right, respectively. The input images of coronal and horizontal planes, as well as the thermal maps of the implant insertion point and the implant root tip point obtained, including implant placement points. The specific location of the the implant insertion point and the implant root tip point is the coordinate of the point with the highest predicted value, usually located at the center of the white circle. It can be seen that the bone density of the root apex is appropriate, and it maintains a safe distance from the adjacent tooth roots and maxillary sinus. Compared to directly using point coordinate regression to predict key points, the heatmap can use Gaussian distribution to represent the position of key points, while containing confidence information. Even if there are small errors, the accuracy of the prediction results can be guaranteed.

In an optional embodiment, the implantation posture and size information of the dental implant are determined based on a key points heatmap. Based on the key points heatmap, the implantation posture and size information of the dental implant can be determined. For example, the rotation angle and size of the implant can be determined by the position and relative distance of the key points; The dental implant model can be generated based on implantation posture and size information. It can be a 3D dental implant model generated by using computer-aided design software or other modeling tools based on the determined implantation posture and size information.

Optionally, obtaining the 3D oral image of a target object, including: obtaining multiple 2D oral images of the target object; performing 3D transformation on the multiple 2D oral images to obtain the 3D oral image.

The aforementioned 2D oral images refer to images of oral structures presented on a plane, which can be obtained through devices such as digital cameras, oral scanners, or X-rays. 2D oral images play an important role in dental diagnosis and treatment, helping dentists or dental professionals understand the patient's oral condition and make corresponding diagnosis and treatment plans.

In an optional embodiment, obtaining multiple 2D oral images of the target object can be achieved by using an oral photography device to obtain multiple 2D oral images, which can ensure coverage of different perspectives and regions of the target object's oral cavity; To convert multiple 2D oral images into 3D oral images, the obtained images can be preprocessed first, and then feature points can be located and matched by using computer vision algorithms for each 2D oral image. The 3D reconstruction method in computer vision can be used to convert multiple 2D oral images into 3D oral images. Finally, the obtained 3D oral images can be further processed and analyzed based on the geometric and topological information of the 3D images, such as surface reconstruction, volume calculation, tooth segmentation, etc.

Optionally, performing 3D transformation on the multiple 2D oral images to obtain the 3D oral image, including: performing 3D transformation on the multiple 2D oral images to obtain an initial 3D oral image; resampling multiple voxels in the initial 3D oral image to the same voxel spacing to obtain the 3D oral image.

The aforementioned resampling refers to changing the sampling rate of data or images, that is, changing the spacing or density of data points in the data or image, in order to adapt it to specific needs or requirements. In 3D oral image processing, resampling is commonly used to adjust the spacing or resolution of voxels (volume pixels) in 3D oral images, making them have consistent spacing or resolution. This can help improve the consistency and comparability of 3D oral images, making subsequent processing and analysis more accurate and reliable.

In an optional embodiment, perform 3D transformation on multiple 2D oral images to obtain an initial 3D oral image. This can be achieved by using computer vision algorithms to locate and match feature points for each 2D oral image, and using 3D reconstruction methods in computer vision to restore depth information and shape from the images, transforming multiple 2D oral images into the initial 3D oral image; Resampling multiple voxels in the initial 3D oral image to the same voxel spacing to obtain a 3D oral image can be achieved by processing the initial 3D oral image and resampling its voxels to the same voxel spacing using interpolation or resampling algorithms, ensuring that the voxels in the 3D oral image have consistent spacing and resolution.

Optionally, resampling the multiple voxels in the initial 3D oral image to the same voxel spacing to obtain the 3D oral image, including: resampling the multiple voxels in the initial 3D oral image to the same voxel spacing to obtain a target 3D oral image; cropping the interest region of the target 3D oral image to obtain a 3D oral image, wherein the interest region is configured to represent the area where the tooth of the target object are located.

In an optional embodiment, multiple voxels in the initial 3D oral model are resampled to the same voxel spacing to obtain the target 3D oral image. This can be achieved by first determining the required voxel spacing or resolution based on requirements and application needs, and then using a resampling algorithm to resample the voxels in the initial 3D oral model to the target voxel spacing. Finally, the voxel positions and indices are reallocated and reorganized to generate the target 3D oral image with the same voxel spacing; Crop the region of interest of the target 3D oral image to obtain a 3D oral image. This can be done as needed by cropping the region of interest of the target 3D oral image, as shown in FIG. 2a and FIG. 2b, which illustrate the marked region of interest. This can be achieved by defining the boundaries of the region of interest or using a mask. The cropped image will only contain the data of the region of interest, which can help reduce processing complexity and improve processing efficiency.

Optionally, predicting the key points of the dental implant based on the tooth position region to obtain the restoration dental model, including: predicting the key points of the dental implant based on the tooth position region to obtain a prediction result; generating the restoration dental model in the 3D oral model based on the prediction result.

In an optional embodiment, the key points of dental implants can be predicted based on the tooth position region, and the prediction results can be obtained by using image analysis and pattern recognition methods. A trained implant key points prediction model can be used to predict the key points of dental implants based on the tooth position region. The implant key points prediction model can be a deep learning model used to predict the key points of dental implants. It should be noted that other methods can also be used to predict the key points of dental implants, and this is not limited here.

In an optional embodiment, the dental implant model can be generated in a 3D oral model based on the predicted results. This can be achieved by first processing and converting the key points data of the predicted dental implant, and then using computer-aided design software or other 3D modeling tools to draw the shape and structure of the dental implant based on the position and size of the key points, creating a dental implant model. Finally, based on the actual material and appearance characteristics of the dental implant, textures and materials can be added to the dental implant model, and parameters such as lighting, shadows, and reflections can be adjusted and optimized as needed to achieve rendering of the model. FIG. 4 is a schematic diagram of an optional root bone fusion and dental implant prediction effect based on the embodiment of the present invention. FIG. 4 shows the generated dental implant prediction effect. Through the fused 3D mesh, the placement position of the dental implant can be clearly observed to ensure that the distance from other tissue structures is within a safe range. It should be noted that other methods can also be used to obtain the dental implant model based on the key points of dental implants, and there is no limitation here.

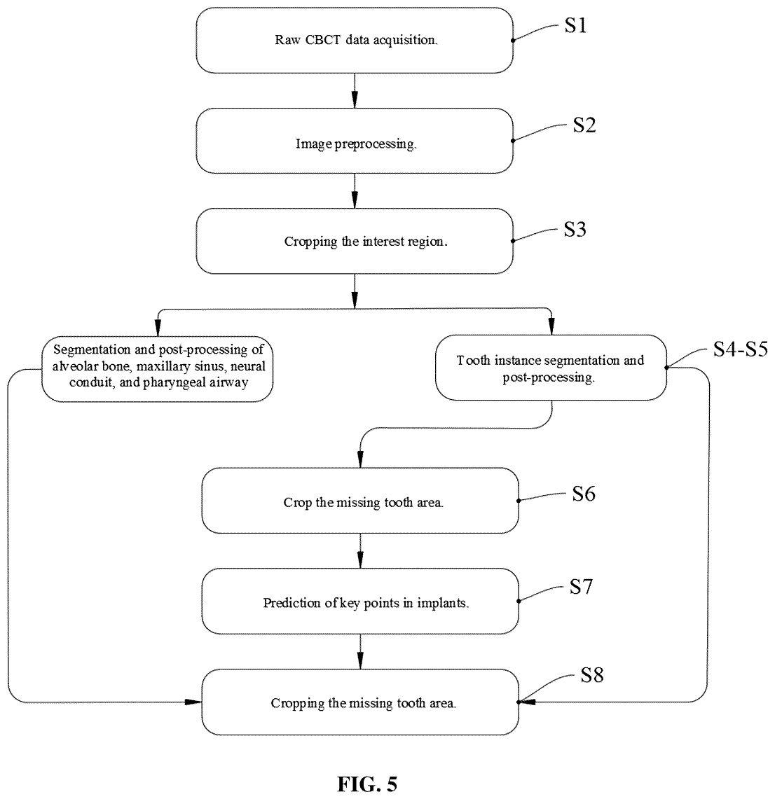

Below, a preferred embodiment of the present invention will be described in detail with reference to FIG. 5.

The present invention provides a method for segmenting oral CBCT images and predicting implant orientation. After data preparation, model training, testing deployment, and other steps, the algorithm can be applied to actual implantation scenarios. The inference process is shown in FIG. 5, which includes the following steps:

S1: Raw CBCT data acquisition. The format of the original file is mostly DICOM, which is a stacked cross-sectional 2D image. In order to facilitate the processing of deep learning networks, it is necessary to convert them into the NIFTI file format that directly represents 3D information.

S2: Image preprocessing. Voxel spacing refers to the actual distance between adjacent voxels, and different scanning devices or parameters may cause different voxel spacings, with values concentrated in the range of 0.1 mm˜0.4 mm. If the voxel spacing of the data is inconsistent, it will increase the computational complexity of the model and make it difficult to extract effective features, thereby reducing training and testing efficiency. The present invention resamples all data and its 3D to the same voxel spacing to ensure data consistency. Different CT scanning device, scanning parameters, scanning positions, and other factors may also lead to differences in image brightness, contrast, etc. Gray level histogram matching can reduce the differences between images and improve the generalization of the model. Due to the different CT values of various oral tissue structures, such as air at −1000 HU and bones at 150-1000 HU, limiting window width and position can eliminate interference from unrelated structures. At the same time, map the CT values within the window to between 0 and 1 for easier model calculation.

S3: Cropping the interest region. For the large window CBCT scanned by some devices, the alveolar bone only occupies a small area, and it takes a long time for the model to accurately segment the complete CBCT. As shown in the regions of interest labeled in FIG. 2a, FIG. 2b and FIG. 2d, the present invention extracts the image with the minimum bounding matrix as the input for subsequent models based on the results of fast coarse segmentation, which can effectively shorten the computation time.

S4: Segmentation and post-processing of alveolar bone, maxillary sinus, neural conduit, and pharyngeal airway. The present invention adopts the Unified Neural Network for Transfer and Representation Learning, abbreviated as UNETR Network, which divides the input 3D image into a series of uniform, non overlapping blocks and projects them into an embedding space using a linear layer. The image block sequence is passed to the Transformer module after adding a positional embedding, where the Transformer model is a deep learning model used for natural language processing tasks. Then use convolution to extract the encoded representations of different layers in the Transformer, and merge them with the decoder through skip connections to predict the final organizational structure. The post-processing step involves setting a volume threshold, removing isolated interfering small areas, and reconstructing similar shapes of disconnected neural conduits through curve fitting methods. FIG. 2c shows the segmentation and mesh reconstruction results of the upper and lower alveolar bones, maxillary sinus, neural conduit, and pharyngeal airway in various dimensions. The upper alveolar bone and maxillary sinus are bounded by the horizontal plane of the condyle, and the regions of each tissue structure are clearly visible.

S5: Tooth instance segmentation and post-processing. Tooth segmentation and alveolar bone segmentation are independent of each other, but both use the UNETR network with 33 channels at the output, corresponding to the background and 32 tooth, which are numbered by using numerical labeling. In the post-processing stage, difficult data results can be corrected. For example, in the case of damaged tooth and orthodontic correction, the model segmentation results may have incorrect numbering, meaning that the same tooth contains multiple numbers. The present invention uses the largest proportion of tooth numbers to represent the connected area of a single tooth, while using methods such as corrosion expansion and setting thresholds to avoid the impact of merging tooth numbers on connected tooth. The results of tooth instance segmentation and mesh reconstruction are shown in FIG. 2d. The morphology from the crown to the root tip is complete, the tooth number is correct, and the mesh surface is relatively smooth.

S6: Crop the missing tooth area. According to the tooth segmentation results, the missing tooth position of the patient can be determined. The spatial size of the missing tooth position can be determined by the distance between adjacent tooth. If the implantation conditions are met, the adjacent tooth will be used as the boundary to extend outward for a certain distance for cutting.

S7: Prediction of key points in implants. Using the cropped image from the previous step as input for the implant key points prediction model, the model can learn alveolar bone density information from CBCT and output it as a heatmap of the implant and root apex points.

FIG. 3 shows the heatmap of the input image, implantation point, and root apex point. The specific positions of the implantation point and root apex point are the coordinates of the point with the highest predicted value, usually located at the white center of the circle. It can be seen that the bone density at the root apex is appropriate, and a safe distance is maintained from the adjacent tooth roots and maxillary sinus. Compared to directly using point coordinate regression to predict key points, heatmaps can use Gaussian distributions to represent the positions of key points and contain confidence information, ensuring the accuracy of prediction results even with small errors.

S8: Three dimensional visualization. The present invention simplifies the labeling of alveolar bone training data and does not accurately label dental cavities. During root bone fusion, Boolean operations are used to replace the overlapping area with the root of the tooth. Based on the coordinates, axial direction, and length information of the key points of the implant calculated in the previous step, the implant can be simulated. As shown in FIG. 4, the placement position of the implant can be clearly observed through the 3D mesh after fusion to ensure that the distance from other tissue structures is within a safe range. The subsequent implant guide generation and crown restoration work can be completed based on this basis.

The present invention provides an automated method for oral CBCT image segmentation and implant prediction. The present invention is the first to use deep learning methods to predict the implant insertion point and the implant root tip point of the dental implant from cone beam computer tomography (CBCT) 3D data, and achieve process automation. CBCT more accurately reflects the relationship between tooth structure and surrounding organs, and can comprehensively evaluate the patient's tooth condition, such as tooth misalignment, degree of alveolar bone defect, etc. Deep learning methods can provide more accurate implant prediction, determine the center points of the two ends of the implant, and thus more effectively avoid implant misalignment and improve implant survival rate. For the application scenario of digital implantation beside the chair, dentists only need to upload the patient's CBCT data. After algorithm calculation, they can obtain the implant point coordinates, root apex point coordinates, axial and length information of the missing tooth implant, providing data support for subsequent processes such as implant guide generation and crown restoration.

Use the segmented 3D structures of alveolar bone, tooth, maxillary sinus, neural conduit, etc. to analyze and verify the predictive effect of the implant. The segmentation of alveolar bone and tooth can help determine the position of the implant insertion point and ensure good contact between the implant and alveolar bone. In addition, the segmentation of alveolar bone can also help evaluate the thickness and morphology of alveolar bone to determine the axial and length of the implant. The segmentation of the maxillary sinus and neural conduit can help evaluate the distance between the implant and the maxillary sinus and neural conduit to ensure the safety of the implant without causing damage to the nerves.

The U-shaped network integrated with the Vision Transformer (ViT module) and UNETR network were simultaneously applied to CBCT image segmentation and implant prediction tasks. Introducing Transformer models into the field of image processing can improve the ability of neural networks to handle long-distance dependencies in images. UNETR uses the ViT module as the encoder and employs deconvolution and skip connections to gradually restore image features. This network has achieved excellent results in multi organ segmentation of the lungs. The present invention applies it to segmentation of tooth and implant prediction and achieves good results.

Reduce the impact of different CBCT devices and difficult data through pre-processing and post-processing steps. Preprocessing operations include common resampling to the same voxel spacing, framing window width and level normalization. Specifically, The present invention adopts a grayscale histogram matching method to adapt to data from different sources. For CBCT data with poor reconstruction quality, the output results of the model generally are issues such as tooth adhesion, category errors, and neural conduit disconnection. In the post-processing stage, operations such as dilation and corrosion, connected domain analysis, and curve fitting are used to optimize such problems.

The present invention has the most direct impact in the field of oral implantation, as it is a key component of the digital and intelligent chair side implantation system. For patients, it can reduce surgical time and pain, improve the accuracy and success rate of implant implantation, and reduce surgical failure rates. For dentists, it can improve surgical efficiency, reduce operational difficulty and surgical risks. For the industry, it can promote the development of oral implant technology, improve technical level and medical quality.

The present invention is not only beneficial to the field of implantation, but also contributes to orthodontic treatment, maxillofacial surgery, and pulp disease treatment. For example, precise segmentation of tooth can be used for digital design of orthodontic plans, digital design of dentures and restorations. The precise segmentation of alveolar bone, maxillary sinus, and pharyngeal airway can be used to assess the difficulty and risks of oral and maxillofacial surgery and maxillary sinus elevation surgery in advance.

Optionally, obtaining a tooth number of the tooth to be restored and an outer contour of the restoration area of the tooth to be restored in response to the restoration type being the crown restoration type or the inlay restoration type; determining a preset restoration dental model of the tooth to be restored based on the tooth number; deforming the preset restoration dental model to obtain the restoration dental model based on the key points of the tooth to be restored and the outer contour of the area to be restored

Among them, the tooth to be restored is a dental model to be added with a restoration dental model, the tooth number is configured to represent the position information of the tooth to be restored in the dental model sequence, and the outer contour of the restoration area is the outer contour of a portion of a tooth body area in the tooth to be restored.

The aforementioned tooth to be restored can be a model used to display the structure and morphology of the user's tooth to be restored. Common tooth defects in the tooth to be restored include caries, wear, fracture, and loss. The tooth to be restored can be used in the field of oral medicine to provide diagnostic basis for the user's dental restoration surgery.

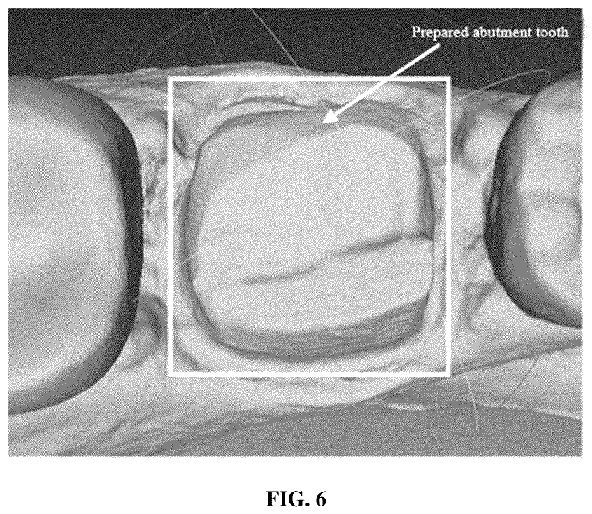

According to the defect situation and actual needs of the tooth to be restored, the restoration methods can be crown restoration and inlay restoration. Crown restoration requires grinding the missing tooth to obtain a base tooth, and then installing a crown on the base tooth. FIG. 9 is a schematic diagram of a 3D dental model in which a crown is installed on the base tooth according to an optional crown restoration embodiment of the present invention, as shown in FIG. 9. When the restoration method is crown restoration, the tooth to be restored can be a pre ground base tooth. FIG. 6 is a schematic diagram of a 3D dental model of a pre ground base tooth in an optional crown restoration embodiment of the present invention, as shown in FIG. 6, which is a schematic diagram of crown restoration. Schematic diagram of the 3D dental model of the already ground abutment tooth in China; Embedding restoration can be achieved by first removing the damaged part from the missing tooth to obtain an inlay, and then bonding the inlay to the missing tooth to restore its shape and appearance; When the restoration method is inlay restoration, the tooth to be restored can be a missing tooth obtained after removing the damaged part.

The aforementioned tooth number can be a marking system used to describe and distinguish different tooth, which may vary in different countries and regions. Each tooth has a unique tooth number for diagnosing and recording oral problems, helping dentists and oral physicians accurately describe and locate specific tooth. Taking the International Orthodontic Method as an example, the oral cavity is divided into four quadrants, each with eight tooth numbers. Starting from the incisor (central incisor), the tooth are numbered counterclockwise. The tooth in the upper right quadrant are numbered 1-8, the tooth in the lower right quadrant are numbered 9-16, the tooth in the lower left quadrant are numbered 17-24, and the tooth in the upper left quadrant are numbered 25-32. It should be noted that different dental number systems may have different encoding rules and annotation methods.

The aforementioned outer contour of the restoration area to be restored can be the boundary line of the area where the tooth needs to be restored. Specifically, it refers to the shape and position of the tooth around the restoration area to be restored. When repairing tooth, determining the outer contour is crucial for preserving the shape and function of the tooth, which can help dentists better restore the appearance and bite function of the tooth during the repair process.

In an optional embodiment, obtaining the tooth number of the tooth to be restored can be achieved by first determining the tooth number system used, observing the tooth to be restored, and combining it with a tooth chart. By comparing the characteristics of the tooth to be restored on the tooth to be restored with the tooth number on the chart, the tooth number of the designated tooth to be restored can be determined.

In an optional embodiment, when the restoration method is crown restoration, the outer contour of the area to be restored of the tooth to be restored can refer to the shape and position of the tooth around the abutment. To obtain the outer contour of the area to be restored of the tooth to be restored, a 3D image of the tooth structure in the user's mouth can be first obtained through an oral scanner or oral CT. Based on the position and shape of the area to be restored, a drawing tool or selection tool in the software can be used to select the area to be restored on the dental model. Finally, a contour extraction tool can be used in the software to extract the shape and position of the tooth around the abutment based on the selected area to be restored.

In another optional embodiment, when the restoration method is inlay restoration, the outer contour of the restoration area to be restored of the tooth to be restored can refer to the shape and position of the tooth around the damaged tooth. To obtain the outer contour of the restoration area to be restored of the tooth to be restored, a 3D image of the tooth structure in the user's mouth can be obtained through an oral scanner or oral CT scan. Based on the position and shape of the restoration area to be restored, a drawing tool or selection tool in the software can be used to select the area to be restored on the dental model. Finally, a contour extraction tool can be used in the software to extract the shape and position of the tooth around the damaged tooth based on the selected area to be restored.

It provides a basis for generating a restoration dental model based on the tooth number of the tooth to be restored and the outer contour of the repair area of the tooth to be restored in the subsequent steps by obtaining the tooth number of the user's tooth to be restored and the outer contour of the repair area of the tooth to be restored.

The aforementioned preset restoration dental model can be a vertebral dental model corresponding to the user's tooth to be restored, used to simulate the characteristics of human vertebral tooth.

The aforementioned key points may include but are not limited to: sharp points, troughs, grooves, ridges, center points, edges, slopes, etc. These key points in the tooth to be restored are used to represent the shape, position, and inclination of the tooth to be restored. These key points help provide more accurate structural data of the tooth to be restored for dentists or oral physicians to diagnose, treat, and study. The specific key points types can be adjusted and supplemented based on specific needs and purposes.

In an optional embodiment, when the restoration method is crown restoration, the preset restoration dental model can be a preset crown model. The preset restoration dental model corresponding to the tooth to be restored can be determined based on the tooth number, which can be searched for in the standard dental model library based on the tooth number of the tooth to be restored.

In another optional embodiment, when the restoration method is inlay restoration, the preset restoration dental model can be a preset inlay model, and the preset restoration dental model corresponding to the tooth to be restored can be determined based on the tooth number. The corresponding preset inlay model can be searched in the standard dental model library based on the tooth number of the tooth to be restored.

In an optional embodiment, when the restoration method is crown restoration, the key points of the tooth to be restored can be the key points of the abutment tooth. The key points of the tooth to be restored can be determined based on the tooth number system used, by first finding the corresponding tooth to be restored, and determining the key points of the abutment tooth based on the remaining part and requirements of the tooth to be restored.

In another optional embodiment, when the restoration method is inlay restoration, the key points of the tooth to be restored can be the key points of the missing tooth. The key points of the tooth to be restored can be determined based on the tooth number system used, which can first find the corresponding tooth to be restored, and determine the key points of the missing tooth based on the remaining part and requirements of the tooth to be restored.

By obtaining the preset restoration dental model corresponding to the tooth to be restored and the key points of the tooth to be restored, it is convenient for subsequent steps to deform the preset restoration dental model based on the key points and the outer contour of the area to be restored, and obtain the restoration dental model.

The aforementioned restoration dental model can be a 3D dental model used to simulate and display the parts of tooth to be restored. The generated restoration dental model can help dentists or oral physicians determine the shape, size, and position of dental restorations, as well as develop suitable treatment plans.

The aforementioned preset restoration dental model can be a preset crown model or a preset inlay model. This is only an example and is not specifically limited. The preset crown model can be a preset standard crown model, which can be deformed to different degrees to make the obtained restoration dental model applicable to the dental model to be added with a crown; The preset embedded model can be a standard embedded model that has been preset. By deforming the preset embedded model to varying degrees, the resulting restoration dental model can be applied to the dental model of the partially damaged tooth to be restored.

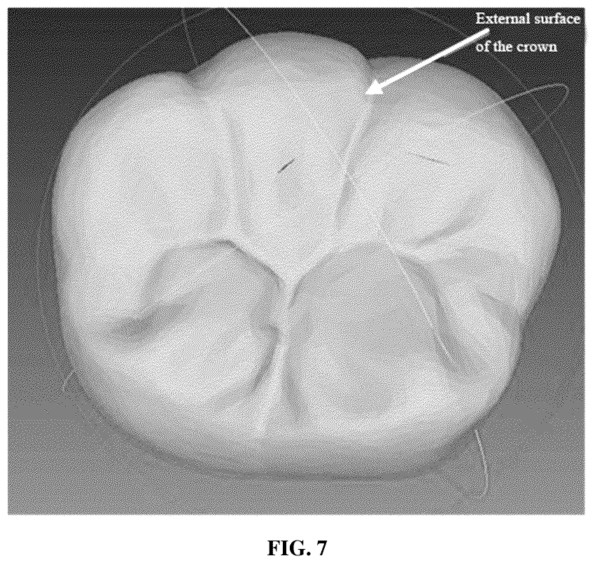

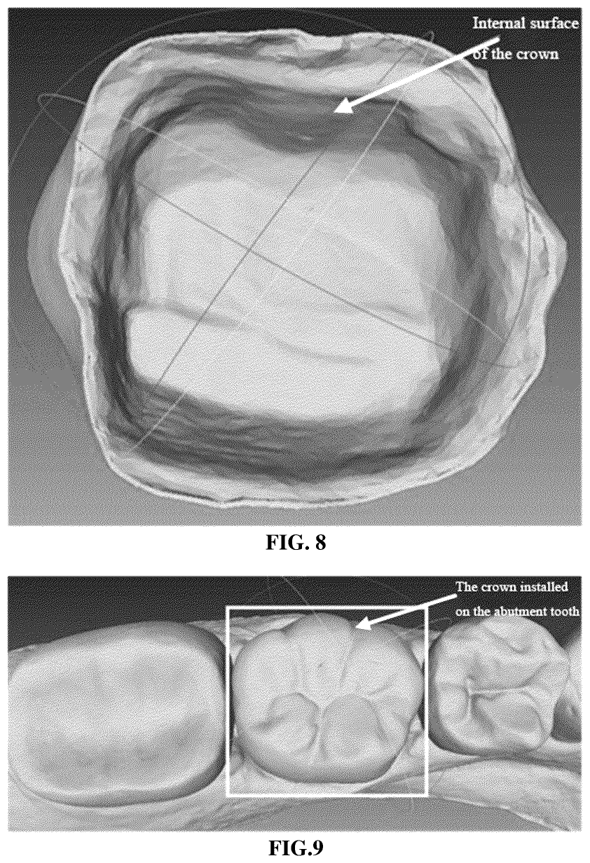

In an optional embodiment, when the restoration method is crown restoration, the preset dental crown model can be deformed based on the key points of the abutment and the shape and position of the tooth around the abutment to obtain the crown model. The key points can be matched with the key points of the preset crown model to establish a corresponding relationship between the two, and then the preset crown model can be deformed based on the key points matching result and the outer contour of the area to be restored. By controlling the key points and outer contour, the preset crown model can undergo corresponding deformation in the area to be restored to obtain the crown model. FIG. 7 is a schematic diagram of a 3D dental model obtained outside the dental crown in an optional dental crown restoration according to an embodiment of the present invention. As shown in FIG. 7, it is a schematic diagram of the 3D dental model outside the crown obtained in crown restoration. FIG. 8 is a schematic diagram of the 3D dental model inside the crown obtained in an optional dental crown restoration according to an embodiment of the present invention, as shown in FIG. 8, FIG. 8 is a schematic diagram of the 3D dental model inside the crown obtained during the restoration of the crown.

In another optional embodiment, when the restoration method is inlay restoration, the preset inlay model can be deformed based on the shape and position of the damaged key points and the surrounding tooth of the damaged tooth to obtain the inlay model. The key points can be matched with the key points of the preset inlay model to establish a corresponding relationship between the two, and then the preset inlay model can be deformed based on the key points matching result and the outer contour of the area to be restored. By controlling the key points and outer contour, the preset inlay model can undergo corresponding deformation in the area to be restored to obtain the inlay model.

By following the above steps, the restoration dental model was obtained by deforming the preset restoration dental model, achieving rapid generation of the restoration dental model.

In the embodiment of the present invention, the tooth number of the tooth to be restored and the outer contour of the area to be restored of the tooth to be restored are obtained. The tooth to be restored is a dental model to be added with a restoration dental model, and the tooth number is used to represent the position information of the tooth to be restored in the sequence of dental models. The outer contour of the area to be restored is the outer contour of a portion of the tooth body area in the tooth to be restored; Determine the preset restoration dental model corresponding to the tooth to be restored based on the tooth number, and identify the key points of the tooth to be restored. The key points are used to represent the key points on the standard tooth corresponding to the tooth to be restored; Based on the key points and the outer contour of the area to be restored, the preset restoration dental model is deformed to obtain a restoration dental model, which realizes the generation of restoration dental models based on the tooth number of the tooth to be restored, the key points of the tooth to be restored, and the outer contour of the area to be restored. Compared with the traditional method of generating restoration dental models manually, the method proposed in the above steps shortens the time for generating dental implant models. The technical solution proposed in The present invention improves the efficiency of restoration dental model generation in related technologies and solves the technical problem of low efficiency in manually generating restoration dental models in related technologies.

Optionally, the method for generating the restoration dental model including: determining an adjacent tooth number of an adjacent dental model based on the tooth number, wherein the adjacent dental model is the adjacent dental model of the tooth to be restored, and the adjacent tooth number is configured to represent the position information of the adjacent dental model in the dental model sequence; determining an adjacent tooth point cloud data of the adjacent dental model based on the adjacent tooth number; adjusting a gap between the restoration dental model and the adjacent dental model based on the adjacent tooth point cloud data.

The aforementioned adjacent dental model can refer to a model of adjacent tooth to be restored, and when repairing tooth, adjacent tooth need to be considered. This method of using models of adjacent tooth for restoration can maintain coordination and stability between tooth.

The aforementioned adjacent tooth number can be the tooth number of the adjacent tooth to be restored, which can be determined according to the tooth number system, where the tooth number system defines each tooth number and corresponding tooth position.

The aforementioned adjacent tooth point cloud data can refer to the 3D coordinate point data of adjacent tooth obtained through 3D scanning technology. By scanning the tooth in the patient's mouth, laser scanners can quickly obtain the 3D coordinate point data of adjacent tooth and generate point cloud models. In the fields of tooth restoration, implantation, correction, etc., adjacent tooth point cloud data can provide dentists with detailed information on the morphology of adjacent tooth and help them formulate more accurate treatment plans.

In an optional embodiment, the adjacent tooth number of the adjacent dental model is determined based on the tooth number, which can be determined according to the tooth number system. For example, if the tooth number to be restored is tooth #1 (the first upper right incisor), then the adjacent tooth of the tooth can be the second upper right incisor (tooth #2) and the first upper right premolar (tooth #3).

In an optional embodiment, when the restoration method is crown restoration, the gap between the crown model and the adjacent dental model can be adjusted based on the adjacent tooth point cloud data, which can be processed by denoising, filtering, and aligning the point cloud data; Align the crown model with adjacent tooth point cloud data; Calculate the gap between the crown model and adjacent dental model by comparing their overlapping parts; According to the evaluation results, adjust the dental crown model to reduce or increase the gap; Reevaluate the gap between the adjusted crown model and adjacent dental model; If further optimization of the gap is needed, different adjustment methods or algorithms can be tried to achieve it.

In another optional embodiment, when the restoration method is inlay restoration, the gap between the inlay model and the adjacent dental model can be adjusted, and the gap between the inlay model and the adjacent dental model can be adjusted based on the adjacent tooth point cloud data, which can be processed by denoising, filtering, and aligning the point cloud data; Align the embedded model with adjacent tooth point cloud data; Calculate the gap between the embedded model and the adjacent dental model by comparing their overlapping parts; According to the evaluation results, adjust the embedded model to reduce or increase the gap; Reevaluate the gap between the adjusted embedded model and the adjacent dental model; If further optimization of the gap is needed, different adjustment methods or algorithms can be tried to achieve it.

Optionally, the method for generating the restoration dental models including: determining an opposing dental model corresponding to the tooth to be restored, wherein the opposing dental model is a dental model that has an occlusal relationship with the tooth to be restored; determining an opposing tooth point cloud data of the opposing dental model based on a spatial position relationship between the tooth to be restored and the opposing dental model; adjusting the occlusion relationship between the restoration dental model and the opposing dental model based on the opposing tooth point cloud data.

The aforementioned dental model can refer to a model of tooth that are in a corresponding biting relationship with the tooth to be restored, and when repairing tooth, it is necessary to consider the tooth that are in a corresponding biting relationship with the upper and lower tooth. This method of using a model of the maxillary tooth for restoration can ensure stable occlusion between the maxillary tooth.

The aforementioned occlusal relationship can refer to the contact and movement relationship between the upper and lower tooth. A normal occlusal relationship between the upper and lower tooth can be a complete docking of the upper and lower tooth, with the upper tooth slightly protruding outward and the lower tooth biting stably.

In an optional embodiment, the point cloud data of the maxillary model is determined based on the spatial position relationship between the tooth to be restored and the maxillary model. Software or algorithms can be used to match the spatial position relationship between the tooth to be restored and the maxillary model by comparing the feature points, edges, or surface features of the two models, and determine the point cloud data of the maxillary model.

In an optional embodiment, when the restoration method is crown restoration, the occlusal relationship between the crown model and the maxillary tooth can be adjusted based on the point cloud data of the maxillary tooth. The occlusal relationship between the crown model and the maxillary tooth can be analyzed and measured to determine the position of the crown model during occlusion. This can be achieved by using bite analysis tools in computer-aided design software. Based on the results of bite analysis, the crown model can be fine tuned to ensure good bite relationship with other tooth.

In another optional embodiment, when the restoration method is inlay restoration, the inlay model can be first added to the missing tooth to be restored, and then the bite relationship between the inlay model and the maxillary tooth can be adjusted. Based on the point cloud data of the maxillary tooth, the bite relationship between the inlay model and the maxillary tooth can be adjusted by analyzing and measuring the bite relationship between the maxillary tooth to determine the position of the inlay model during bite. This can be achieved by using bite analysis tools in computer-aided design software. Based on the results of bite analysis, the inlay model can be fine tuned to ensure good bite relationship with other tooth.

Optionally, the method for generating the restoration dental model including: displaying multiple candidate dental models on an operating interface in response to input instruction acting on the operation interface; displaying the tooth to be restored from the multiple candidate dental models on the operation interface in response to the confirmation instruction acting on the operation interface.

In an optional embodiment, when the restoration method is crown restoration, the tooth to be restored can be an abutment dental model. In response to confirmation instructions on the operation interface, multiple candidate dental models of the abutment dental model are displayed on the operation interface. Dentists or dental experts can select the tooth to be restored from multiple damaged tooth through the operation interface, as shown in FIG. 5, which is a schematic diagram of the 3D dental model of the grounded abutment tooth in crown restoration.

In another optional embodiment, when the restoration method is inlay restoration, the tooth to be restored can be a missing tooth to be restored. In response to a confirmation command acting on the operation interface, the missing tooth to be restored from multiple candidate dental models can be displayed on the operation interface. Dentists or dental experts can select the tooth to be restored from multiple damaged tooth through the operation interface.

In another optional embodiment, when the restoration method is inlay restoration, the tooth to be restored can be a missing tooth to be restored. In response to a confirmation command acting on the operation interface, the missing tooth to be restored from multiple candidate dental models can be displayed on the operation interface. Dentists or dental experts can select the tooth to be restored from multiple damaged tooth through the operation interface.

Optionally, the method for generating a restoration dental model includes: identifying the dental model sequence by using a deep learning model to obtain the tooth to be restored, wherein the deep learning model is obtained by training based on a sample dental model sequence and a sample tooth to be restored.

The aforementioned deep learning model can be a machine learning model that uses multi-layer neural networks for learning and inference. It is based on neural networks and learns data representation through multi-level nonlinear transformations and feature extraction. It is trained based on sample dental model sequences and sample tooth to be restored. When the repair method is crown restoration, the sample tooth to be restored can be the sample base dental model; When the restoration method is embedded restoration, the sample tooth to be restored can be a model of a missing tooth. The above deep learning model consists of an input layer, several hidden layers, and an output layer. The input layer receives the dental model sequence, the hidden layer performs calculations and processing, and the output layer outputs the tooth to be restored.

In an optional embodiment, when the restoration method is crown restoration, the tooth to be restored can be an abutment model. A deep learning model is used to identify the dental model sequence and obtain the abutment model. The deep learning model can refer to a tooth recognition model. Firstly, a separate point cloud model and corresponding tooth number for each tooth are obtained through an object detection and segmentation model. Then, a classification model is used to distinguish normal tooth and the tooth to be restored, thereby obtaining the abutment model.

In another optional embodiment, when the restoration method is inlay restoration, the tooth to be restored can be a missing tooth to be restored. A deep learning model is used to recognize the dental model sequence and obtain the abutment dental model. The deep learning model can refer to a recognition dental model. Firstly, a separate point cloud model and corresponding tooth number for each tooth are obtained through an object detection and segmentation model. Then, a classification model is used to distinguish normal tooth and the tooth to be restored, thereby obtaining the missing tooth to be restored.

Optionally, identifying the dental model sequence by using a deep learning model to obtain the tooth to be restored, including: performing an instance segmentation on the dental model sequence by using a dental segmentation model to obtaining multiple dental models; performing a classification on the multiple dental models by using a dental classification model to obtain the tooth to be restored.

The aforementioned dental segmentation model can be a model used for segmenting tooth images. Dental segmentation can use computer vision and deep learning techniques as needed to accurately segment the tooth region from the tooth image for further analysis and processing.

The aforementioned dental classification model can refer to a model that classifies tooth into different categories or types based on factors such as their morphological characteristics, position, and function. Dental classification models are commonly used in the field of dentistry and can help dentists or oral specialists accurately classify and diagnose patients' tooth.

In an optional embodiment, when the restoration method is crown restoration, the obtained tooth to be restored can be an abutment dental model. The tooth segmentation model is used to perform instance segmentation on the dental model sequence and obtain multiple dental models, which can be based on deep learning methods using deep convolutional neural networks to learn the feature representation of tooth and perform segmentation; Classify multiple dental models by using a tooth classification model and obtain an abutment dental model, which can be achieved by using computer vision and machine learning techniques to classify tooth. It is necessary to extract the morphological features of tooth, such as shape, size, position, etc., and then use classification algorithms to classify tooth.

In another alternative embodiment, when the restoration method is inlay restoration, the obtained tooth to be restored can be a missing tooth to be restored. The tooth segmentation model is used to perform instance segmentation on the dental model sequence and obtain multiple dental models, which can be based on deep learning methods using deep convolutional neural networks to learn the feature representation of tooth and perform segmentation; Using a classification dental model to classify multiple dental models and obtain incomplete tooth to be restored, which can be achieved by using computer vision and machine learning techniques to classify tooth. It is necessary to extract the morphological features of tooth, such as shape, size, position, etc., and then use classification algorithms to classify tooth.

Optionally, determining a preset virtual dental crown corresponding to the tooth to be restored based on the tooth number, including: retrieving the preset restoration dental model corresponding to the tooth to be restored from a preset database based on the tooth number, wherein the preset database includes the preset restoration dental model corresponding to the different tooth number.

The aforementioned preset virtual dental crown can be a virtual crown model generated based on the tooth number of the tooth to be restored, used to simulate the characteristics of the corresponding crown of the tooth to be restored.

The aforementioned preset database is used to store dental restorations corresponding to preset tooth of different tooth numbers.

In an optional embodiment, when the restoration method is crown restoration, the preset restoration dental model can be a preset crown model. The preset crown model corresponding to the tooth to be restored can be retrieved from the preset database according to the tooth number of the tooth to be restored, and the corresponding preset crown model can be found in the preset database according to the tooth number of the tooth to be restored.

In another optional embodiment, when the restoration method is inlay restoration, the preset restoration dental model can be a preset inlay model. The preset inlay model corresponding to the tooth to be restored can be retrieved from the preset database according to the tooth number of the tooth to be restored, and the corresponding preset inlay model can be found in the preset database according to the tooth number of the tooth to be restored.

Optionally, determining the key points of the tooth to be restored, including: determining the key points of the tooth to be restored based on a tooth point cloud data and the tooth number of the tooth to be restored.

In an optional embodiment, when the restoration method is crown restoration, the key points of the abutment can be determined based on the tooth point cloud data and tooth number of the abutment model. The point cloud data of the tooth can be preprocessed first, including noise removal, smoothing, and alignment correction; Based on the tooth number, determine the position of the tooth in the entire oral model. The tooth number is usually composed of the position and number of the tooth, for example, the first tooth in the upper right is tooth 1, and the second tooth in the lower left is tooth 27; Finally, based on the shape and structure of the tooth, the key points of the abutment tooth are extracted, which can include the center point, edge point, and tip point of the tooth. These points can be used for subsequent tooth restoration and treatment.

In an optional embodiment, when the restoration method is inlay restoration, the key points of the missing tooth to be restored can be determined based on the tooth point cloud data and tooth number of the damaged dental model to be restored. The point cloud data of the tooth can be preprocessed first, including noise removal, smoothing, and alignment calibration; Based on the tooth number, determine the position of the tooth in the entire oral model. The tooth number is usually composed of the position and number of the tooth, for example, the first tooth in the upper right is tooth 1, and the second tooth in the lower left is tooth 27; Finally, based on the shape and structure of the tooth, the key points of the damaged tooth to be restored are extracted. These key points can include the center point, edge point, and tip point of the tooth, which can be used for subsequent tooth restoration and treatment.

Optionally, determining the key points based on the tooth point cloud data of the tooth to be restored and the tooth number, including: determining the key points of the tooth to be restored based on the tooth point cloud data, the tooth number, and an adjacent tooth point cloud data of the tooth to be restored; or, determining the key points of the tooth to be restored based on the tooth point cloud data of the tooth to be restored, the tooth number, and an opposing tooth point cloud data; or, determining the key points of the tooth to be restored based on the tooth point cloud data, the tooth number, an adjacent tooth point cloud data, and an opposing tooth point cloud data of the tooth to be restored.

In an optional embodiment, when the restoration method is crown restoration, the key points of the abutment can be determined based on the point cloud data of the dental model, tooth number, and adjacent tooth point cloud data. The key points of the abutment can be determined by first preprocessing the point cloud data of the abutment model, and then determining the position of the tooth to be restored in the entire oral model based on the information of the tooth number. Finally, extract and match algorithms through some features, and the key points of the abutment can be determined based on the point cloud data of the tooth to be restored and the point cloud data of adjacent tooth. When repairing tooth, it is necessary to consider adjacent tooth. This method of using point cloud data of adjacent tooth for repair can maintain coordination and stability between tooth.

In another optional embodiment, when the restoration method is inlay restoration, the key points of the damaged tooth to be restored can be determined based on the point cloud data, tooth number, and adjacent tooth point cloud data of the damaged dental model to be restored. The key points of the damaged tooth to be restored can be determined by first preprocessing the point cloud data of the damaged dental model to be restored, and then determining the position of the tooth to be restored in the entire oral model based on the information of the tooth number. Finally, extract and match algorithms through some features. Determine the key points of the damaged tooth to be restored based on the point cloud data of the tooth to be restored and the point cloud data of adjacent tooth. When repairing tooth, it is necessary to consider adjacent tooth. This method of using point cloud data of adjacent tooth for repair can maintain coordination and stability between tooth.

In an optional embodiment, when the restoration method is crown restoration, the key points of the abutment can be determined based on the point cloud data of the abutment model, tooth number, and maxillary tooth point cloud data. The key points of the abutment can be determined by first pre-processing the point cloud data of the abutment model, and then determining the position of the tooth to be restored in the entire oral model based on the information of the tooth number. Finally, extract and match algorithms through some features. Determine the key points of the tooth based on the point cloud data of the tooth to be restored and the point cloud data of the maxillary tooth. When repairing tooth, it is necessary to consider the tooth that are in a corresponding occlusal relationship with the tooth to be restored. This method of using point cloud data of the relative jaw tooth for repair can ensure a good occlusal relationship between the tooth to be restored and other tooth, and maintain coordination and stability between the tooth.

In another optional embodiment, when the restoration method is inlay restoration, the key points of the missing tooth to be restored can be determined based on the point cloud data, tooth number, and the point cloud data of the maxillary tooth of the damaged dental model to be restored. The key points of the tooth can be determined by preprocessing the point cloud data of the damaged dental model to be restored first, and then determining the position of the tooth to be restored in the entire oral cavity model based on the information of the tooth number. Finally, extract and match algorithms through some features. Determine the key points of the tooth based on the point cloud data of the tooth to be restored and the point cloud data of the maxillary tooth. When repairing tooth, it is necessary to consider the tooth that are in a corresponding occlusal relationship with the tooth to be restored. This method of using point cloud data of the relative jaw tooth for repair can ensure a good occlusal relationship between the tooth to be restored and other tooth, and maintain coordination and stability between the tooth.

In an optional embodiment, key points are determined based on the tooth point cloud data, tooth number, adjacent tooth point cloud data, and maxillary tooth point cloud data of the tooth to be restored. When the restoration method is crown restoration, the key points of the abutment can be determined based on the tooth point cloud data, tooth number, adjacent tooth point cloud data, and maxillary tooth point cloud data of the abutment; When the restoration method is embedded restoration, the key points of the missing tooth to be restored can be determined based on the tooth point cloud data, tooth number, adjacent tooth point cloud data, and maxillary tooth point cloud data of the missing tooth to be restored. When repairing tooth, considering both adjacent tooth and tooth in corresponding bite relationships can maintain coordination and stability between tooth and ensure good bite relationships between the tooth to be restored and other tooth.

Optionally, determining the key points of the tooth to be restored, including: obtaining a tooth data of a symmetrical dental model of the tooth to be restored, wherein the symmetrical dental model is configured to represent a dental model that is symmetrical to the position of the tooth to be restored within a same row of teeth.

The aforementioned symmetrical dental model can refer to a model of tooth that are in a symmetrical position with the tooth to be restored in the oral cavity.

In an optional embodiment, when the restoration method is crown restoration, it may be to obtain tooth data of a symmetrical dental model of the abutment model, and obtain tooth data of a symmetrical dental model of the abutment model. It can also determine the key points based on the tooth point cloud data, tooth number, and symmetrical tooth point cloud data of the abutment model. When repairing tooth, it is necessary to consider tooth that are in a symmetrical position with the tooth to be restored. This method of using point cloud data of symmetrical tooth for repair can fine tune the crown model based on the results of symmetry analysis, which can maintain the coordination and stability between tooth.

In another alternative embodiment, when the restoration method is inlay restoration, it may be to obtain the tooth data of the symmetrical dental model of the damaged dental model to be restored, obtain the tooth data of the symmetrical dental model of the damaged dental model to be restored, determine the key points based on the tooth data, which may be determined based on the tooth point cloud data, tooth number, and symmetrical tooth point cloud data of the damaged dental model to be restored. When repairing tooth, it is necessary to consider tooth that are in a symmetrical position with the tooth to be restored. This method of using point cloud data of symmetrical tooth for repair can fine tune the crown model based on the results of symmetry analysis, which can maintain the coordination and stability between teeth.

Optionally, the method further including: obtaining a dental model from a tooth collection and a scanning type of the dental model, wherein the dental model is a model obtained by scanning the tooth collection, and the tooth collection comprises at least one tooth; predicting the key points of the dental model based on the scanning type to obtain key points position of the dental model; marking the key points of the tooth collection in the dental model based on the scanning type and the key points position.

The aforementioned dental model can be generated based on the appearance and shape information of the user's tooth, which can be used in the field of stomatology field. It provides diagnostic basis for surgeries in the user's mouth, especially in the dental area.

The aforementioned scanning type of dental models may include but are not limited to oral scanner images and computed tomography (CT) scans of the oral cavity. Among them, an oral scanner is a device specifically designed for oral scanning, which can obtain 3D images of oral structures through optical or laser technology. Oral CT is an examination method that obtains images of oral structures through X-ray scanning technology.

The tooth included in the aforementioned tooth collection can be a single tooth, multiple tooth, or all tooth in the user's mouth. There is no limit to the number of tooth included in the tooth collection.

In an optional embodiment, the oral scanner can be used to scan the user's oral cavity and generate a 3D oral model that represents the user's oral structure and tooth information. Optionally, the scanning probe of the oral scanner can be moved inside the user's mouth, and the image processing unit of the oral scanner's computer will automatically generate a 3D image of the oral structure, thereby obtaining the above-mentioned dental model.

In another optional embodiment, multi-layer tomographic images of the interior of the oral cavity can be obtained through oral CT by using the rotating X-ray beam and sensor. After processing by a computer, it can present a 3D image of the oral cavity, thus obtaining the aforementioned dental model.

The dental model which represents the appearance and shape information of the user's tooth can be generated by obtaining the dental model of the tooth collection and the scanning type of the dental model, providing a basis for the subsequent annotation of key points in the user's dental model.

The types and quantities of key points contained in different types of tooth in the above dental model are different. The present invention uses the examples of incisor, posterior incisor, premolars, and premolars to illustrate.

The key points included in the upper incisor are: maxillofacial center point, lingual gingival point, buccal gingival point, mesial midpoint, mesial marginal ridge, distal marginal ridge, lingual mesial apex, lingual distal apex, buccal mesial apex, and buccal distal apex.

The key points contained in the posterior incisor are: maxillofacial center point, lingual gingival point, buccal gingival point, maxillofacial mesial point, maxillofacial distal midpoint, lingual distal apex, buccal proximal apex, and buccal distal apex.

The key points contained in premolars are: maxillofacial center point, lingual gingival point, buccal gingival point, functional apex, non functional apex, mesial midpoint, distal midpoint, mesial marginal ridge, distal marginal ridge, lingual mesial apex, lingual distal apex, buccal mesial apex, and buccal distal apex.

The key points contained in molars are: maxillofacial center point, lingual gingival point, buccal gingival point, non functional mesial apex, maxillofacial buccal point, mesial functional apex, distal functional apex, distal non functional apex, maxillofacial mesial midpoint, maxillofacial distal midpoint, mesial marginal ridge, distal marginal ridge, lingual mesial apex, lingual distal apex, buccal mesial apex, and buccal distal apex.

It should be noted that the different key points mentioned above correspond to different functions, as shown below:

The center point of the maxillofacial region is located in the center of the upper and lower jaws, and is used to determine the vertical position of the tooth.

The lingual gingival point is used to indicate the highest point of the lingual gingiva and to measure the width of the upper and lower dental arches.

The buccal gum point is used to represent the highest point of the buccal gum and is used to measure the width of the upper and lower dental arches.

The mesial point of the maxillofacial region is used to represent the highest point of the mesial points of the two jawbones, and is used to measure the width of the upper and lower dental arches.

The far midpoint of the maxillofacial region is used to represent the highest point of the far midpoint of the two jawbones, and is used to measure the width of the upper and lower dental arches.

The mesial ridge is used to represent the highest point of the ridge line of the tooth in the mesial region of the upper and lower jaws, and is used to measure the width of the upper and lower dental arches.

The distal edge ridge is used to represent the highest point of the tooth edge ridge line in the distal part of the upper and lower jaws, and is used to measure the width of the upper and lower dental arches.

The lingual mesial apex is used to indicate the highest point of the lingual mesial apex of the upper and lower jaws, and is used to measure the width of the upper and lower dental arches.

The lingual distal apex is used to indicate the highest point of the lingual distal apex of the upper and lower jaws, and is used to measure the width of the upper and lower dental arches.

The buccal mesial apex is used to indicate the highest point of the buccal mesial apex of the upper and lower jaws, and is used to measure the width of the upper and lower dental arches.

The buccal distal apex is used to indicate the highest point of the buccal distal apex of the upper and lower jaws, and is used to measure the width of the upper and lower dental arches.

The function of the above key points is to measure the width and shape of tooth and upper and lower jaws, assisting dentists and orthodontists in oral correction and tooth restoration.

Non functional mesial apex is a feature point used to represent the mesial position of the buccal side of the jaw and face, maintaining stability near the midline and enabling correct alignment of upper and lower tooth during occlusion.

The buccal point is a characteristic point located on the buccal side of the jaw and face, used to maintain the aesthetic shape of the incisors and help tooth align correctly during biting.

Mid mesial functional tip: The mid mesial functional tip refers to a feature point located in the mid mesial position, used to maintain the stability of the midline and help tooth align correctly during biting.

Far middle functional tip: Far middle functional tip refers to a feature point located in the far middle position, used to maintain the stability of the far midline and help tooth align correctly during biting.

Far middle non functional tip: Far middle non functional tip refers to a feature point located in the far middle position, used to maintain the stability of the midline and help tooth align correctly during biting.

By identifying the key points mentioned above, it is possible to accurately measure the position and relationship of tooth for treatments such as orthodontic treatment, dental restoration, and crown making.

The key point positions of the aforementioned dental model can be the actual positions of the key points in the 3D dental model. Different representation methods can be used to represent the positions of the key points according to different scanning types. For example, when the scanning type is an oral scanner, the key points heatmap can be used to represent the positions of the key points. The key points heatmap can be a visual representation method that highlights the pixel values around the key points position on the tooth to indicate the importance of the key points. The heatmap can use Gaussian distribution to represent the positions of the key points and contain confidence information. Even if there are small errors, the accuracy of the prediction results can be guaranteed. When the scanning type is oral CT, Cartesian coordinate system or polar coordinate system can be used to represent the positions of key points. In the Cartesian coordinate system, 3D positional information can be represented by three coordinate values (x, y, z), for example, the position of a point can be represented as (x, y, z). In the polar coordinate system, positional information can be represented by the radial distance, polar angle, and height of the polar coordinates. It should be noted that the key points position of the dental model can also be represented in other ways, and are not limited here.

In an optional embodiment, the key points position of the dental model can be obtained based on the scanning type. For example, if the scanning type is an oral scanner image, the key points of the target tooth are determined based on the tooth type of the target tooth. Different types of tooth contain different types and quantities of key points. Based on the determined key points types and quantities, the actual positions of the key points in the 3D dental model can be obtained; If the scanning type is oral CT, the key points of the target tooth are determined as the maxillofacial center point and the points representing the axial direction and length of the tooth. Based on the above key points, the actual position of the key points in the 3D dental model is obtained.

The key points position of the dental model can be obtained by predicting the key points of the dental model based on the scanning type, which can determine the position information of the key points of the target tooth in the dental model and facilitate further annotation of the key points of the tooth set in the dental model in subsequent steps.

The aforementioned annotations can be used to represent different key points through drawing or tracing points and using different colors by using computer software or image editing tools in the dental model.

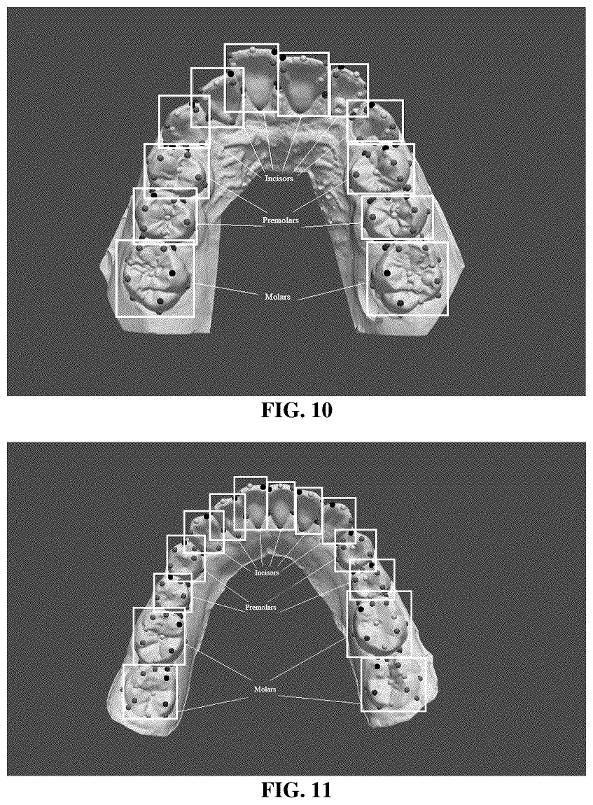

In an optional embodiment, the key points of the tooth collection can be marked in the dental model based on the scanning type and key points position. For example, if the scanning type is an oral scanner image, since there isn't the root of the tooth in the oral scanner image, the key points of the tooth collection can be marked on the crown of the dental model by drawing points according to the different target key points types; FIG. 10 is a schematic diagram of marking key points of tooth collection in an oral scanner image of maxillary tooth according to an embodiment of the present invention. FIG. 10 shows a schematic diagram of marking key points of tooth collection in an oral scanner image of maxillary tooth. FIG. 11 is a schematic diagram of marking key points of tooth collection in an oral scanner image of mandibular tooth according to an embodiment of the present invention. FIG. 11 shows a schematic diagram of marking key points of tooth collection in an oral scanner image of mandibular tooth, where different types of key points can be marked by using different color points.

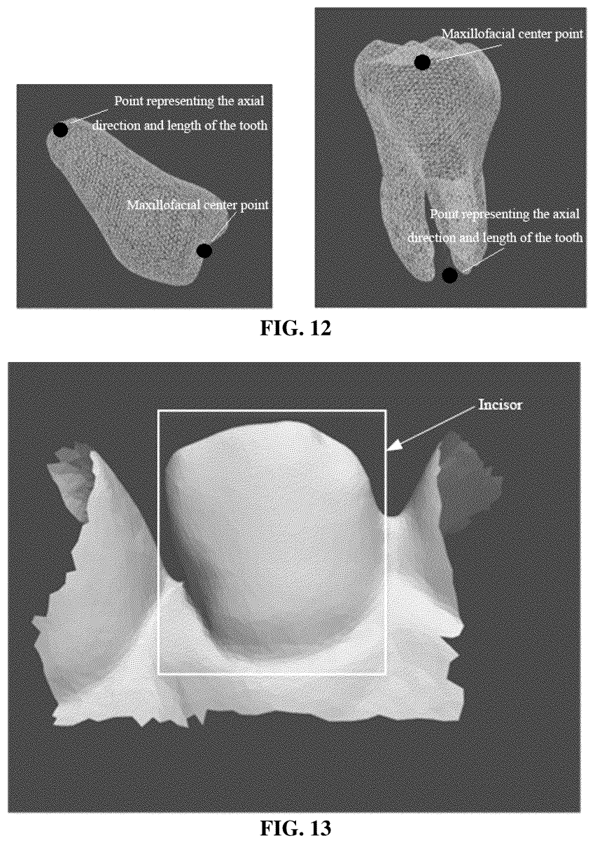

In an optional embodiment, if the scanning type is oral CT, the oral CT will automatically segment the single dental model of the target tooth from the dental model. The single dental model includes a crown and a root. FIG. 12 is a schematic diagram of marking key points in the single dental model obtained by oral CT according to an embodiment of the present invention. The left figure of FIG. 12 shows a single dental model of a tooth with one root, and the right figure of FIG. 12 shows a single dental model of a tooth with three roots. The maxillofacial center point and point representing the tooth axis and tooth length can be marked on the single dental model generated by oral CT by drawing points. As shown in the left figure of FIG. 12 the maxillofacial center point of a tooth with one root and the points representing the axial direction and length of the tooth can be labeled on the surface of the single dental model; The maxillofacial center points of a tooth with three roots shown in the right figure of FIG. 12 can be labeled on the surface of the single dental model, while the point representing the axial direction and length of the tooth can be labeled on the outside of the single dental model. Different color points can be used to label the maxillofacial center point and the points representing the axial direction and length of the tooth, respectively. Marking key points on the single dental models of all target tooth within the tooth collection, achieving the annotation of key points for the tooth collection in the dental model.

It is possible to mark the key points of tooth collection in a dental model based on the scanning type and key points position. The computer can automatically mark the key points of the tooth collection in the 3D image of the user's dental model.

In the embodiments of the present invention, a dental model of tooth collection and a scanning type of the dental model are obtained, wherein the dental model is a model obtained by scanning the tooth collection, and the tooth collection includes at least one tooth; Based on the scanning type, predict the key points of the dental model and obtain the key points position of the dental model; Based on the scanning type and key points position, the key points of the tooth set in the dental model are marked automatically by the computer in the 3D image of the user's dental model. It is easy to note that compared with the traditional method of manually selecting key points, the key points annotation method proposed in the above steps improves the efficiency of key points annotation in the dental model of related technologies and solves the technical problem of low efficiency in manual key points annotation in related technologies.

Optionally, predicting the key points of the dental model based on the scanning type to obtain the key points position of the dental model, including: in response to the scanning type being an image scanning type, obtaining the tooth type of at least one tooth in the tooth collection; Call the first deep learning model corresponding to at least one tooth based on tooth type; Using the first deep learning model to predict the key points of at least one tooth in the dental model and obtain the key points position.

The aforementioned image scanning type can be the 3D images of the user's oral cavity obtained through an oral scanner. The oral scanner is a device that uses optical or laser technology to obtain real-time surface morphology of tooth and oral tissues. It can capture real-time images of the tooth and tissue surfaces by moving the scanning head in the oral cavity, and converts them into digital 3D models or 3D point cloud data.

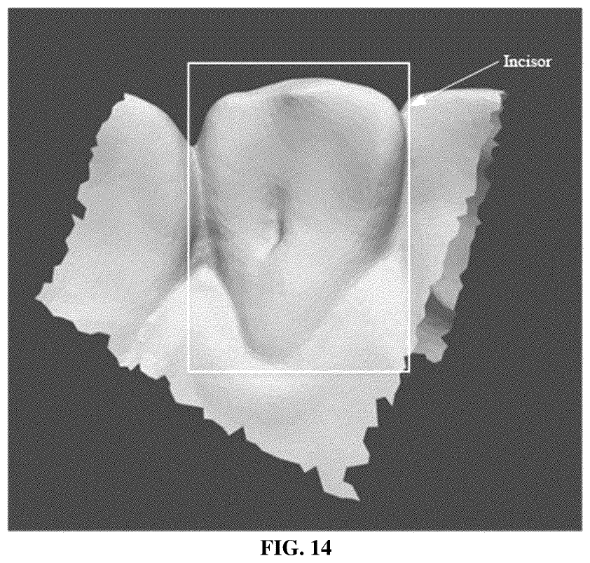

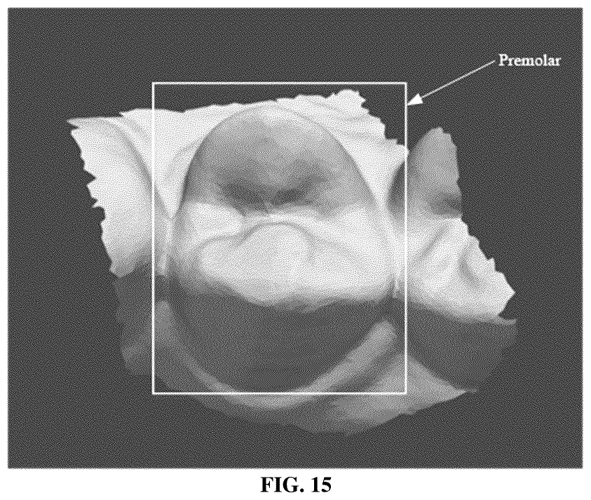

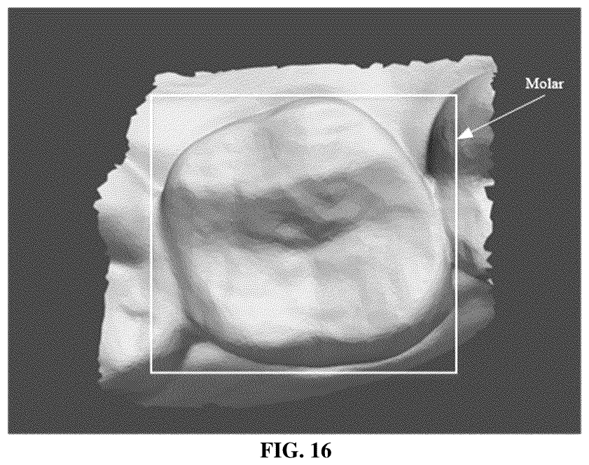

The aforementioned types of tooth can refer to different categories of tooth formed by classifying tooth based on their shape, function, and position. The concept of tooth types helps dentists and oral professionals diagnose, treat, and classify tooth. According to the different positions of tooth in the oral cavity, adult teeth can be divided into anterior and posterior teeth. Among them, the anterior teeth are divided into eight incisors (also known as incisors) located at the front end of the oral cavity and symmetrically distributed in the upper and lower jaws, and four canines adjacent to the incisors and symmetrically distributed in the upper and lower jaws. For example, FIG. 13 is a schematic diagram of the 3D image of the incisor obtained by an oral scanner according to an embodiment of the present invention. FIG. 13 shows the 3D image of the incisor obtained by an oral scanner according to an embodiment of the present invention. FIG. 14 is a schematic diagram of the 3D image of the lower incisor obtained by an oral scanner according to an embodiment of the present invention. The posterior teeth are further divided into those located behind the canines and before the molars, eight premolars symmetrically distributed in the upper and lower jaws, located behind the premolars, twelve molars symmetrically distributed in the upper and lower jaws. For example, FIG. 15 is a schematic diagram of the 3D image of the premolar obtained by an oral scanner according to an embodiment of the present invention. FIG. 15 shows the 3D image of the premolar obtained by the oral scanner. FIG. 16 is a schematic diagram of the 3D image of the molars obtained by an oral scanner according to an embodiment of the present invention. FIG. 16 shows the 3D image of the molars obtained by the oral scanner. It should be noted that everyone's tooth shape and quantity may vary, and some people may have damaged, deformed, or extra tooth.

In an optional embodiment, in response to the scanning type being an image scanning type, the oral scanner can segment the tooth collection of the user's maxillary tooth in the oral scanner image of FIG. 10 to obtain the 3D stereoscopic image of the incisor in FIG. 13, the 3D stereoscopic image of the premolar in FIG. 15, and the 3D stereoscopic image of the molars in FIG. 16. The 3D stereoscopic images of the incisor, premolar, and molars here are only examples and do not represent all the segmented 3D stereoscopic images of the tooth obtained by segmenting the tooth collection of the user's maxillary tooth in FIG. 10. The 3D stereoscopic images of the incisor, premolar, and molars obtained are convenient for subsequent annotation of key points of the target tooth based on their tooth types.

In an optional embodiment, in response to the scanning type being an image scanning type, the oral scanner can segment the tooth collection of the user's mandibular tooth in the oral scanner image of FIG. 11 to obtain the 3D stereoscopic image of the lower incisor in FIG. 14, the 3D stereoscopic image of the premolar in FIG. 15, and the 3D stereoscopic image of the molar in FIG. 16. The 3D stereoscopic images of the lower incisor, premolar, and premolar here are only examples and do not represent all the segmented 3D stereoscopic images of the tooth obtained by segmenting the tooth collection of the user's mandibular tooth in FIG. 11. The 3D stereoscopic images of the lower incisor, premolar tooth, and premolar tooth obtained are convenient for subsequent annotation of key points of the target tooth based on the tooth type of the target tooth.

The aforementioned first deep learning model can be a machine learning model that uses multi-layer neural networks for learning and inference. The first deep learning model can be a semi supervised semantic segmentation network based on deep learning (MinkResUnet, also known as MinkUnet), which is based on neural networks. It can effectively handle sparse and dense 3D point cloud data through multiple levels of nonlinear transformations and feature extraction to learn the representation of data. The first deep learning model can also be other neural network models, which are not limited here. When the scanning type is an oral scanner, the first deep learning model can be used to predict the key points of at least one tooth in the 3D image of the user's oral cavity obtained by the oral scanner, and obtain the position of the key points, where each tooth corresponds to a deep learning model; It can also be the same type of tooth using the same deep learning model, and different types of tooth using different deep learning models; It is also possible to use the same deep learning model for all types of tooth in the oral cavity.

In an optional embodiment, obtaining the tooth type of at least one tooth in the tooth collection can be achieved by using the tooth number of at least one target tooth in the tooth collection, and obtaining the corresponding tooth type of the target tooth according to the encoding rules and annotation methods of the tooth number system. The tooth number system is a system used to identify and name tooth, and defines the tooth position and tooth type corresponding to the tooth number. It should be noted that different tooth number systems may have different encoding rules and annotation methods; As shown in FIG. 10, a 3D of the maxillary tooth collection obtained through an oral scanner can be used to determine the tooth types of each tooth based on the position and characteristics of the target tooth, including the incisors, premolars, and molars; As shown in FIG. 11, a 3D image of the mandibular tooth collection obtained through an oral scanner can be used to determine the tooth types of each tooth, including the incisors, premolars, and molars, based on the position and characteristics of the target tooth.

In an optional embodiment, the first deep learning model corresponding to at least one tooth is called based on the tooth type, which may be different deep learning models set for different tooth types; The first deep learning model is used to predict the key points of at least one tooth in the dental model. It can be obtained through computer technology. The first deep learning model is input with a 3D image of the user's oral cavity obtained through an oral scanner and the tooth number of at least one target tooth. The first deep learning model will output the key points position information of at least one target tooth and represent it in the form of the 3D position coordinates of the point.

Optionally, predicting the key points of the at least one tooth in the dental model by using the first deep learning model to obtain the key points position, including: segmenting the dental model to obtain a target area corresponding to the at least one tooth; predicting the target area by using the first deep learning model to obtain the key points position.

The aforementioned target area can refer to the Region of Interest (ROI, or called ‘interest region’), which represents the dental model corresponding to at least one target tooth in the oral cavity obtained by the oral scanner. The ROI region corresponding to at least one tooth can be segmented from the 3D image of the dental model by the oral scanner.

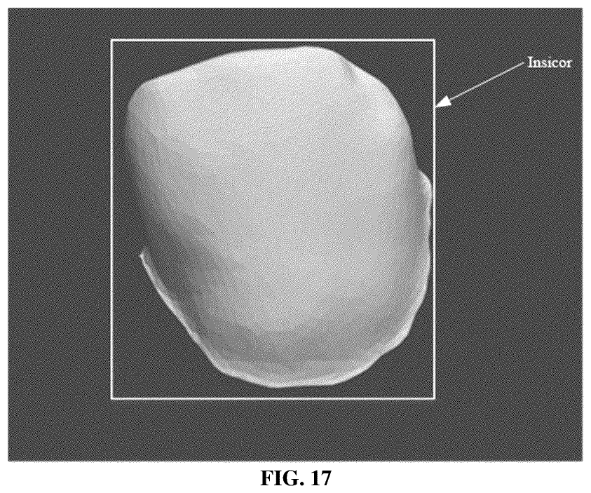

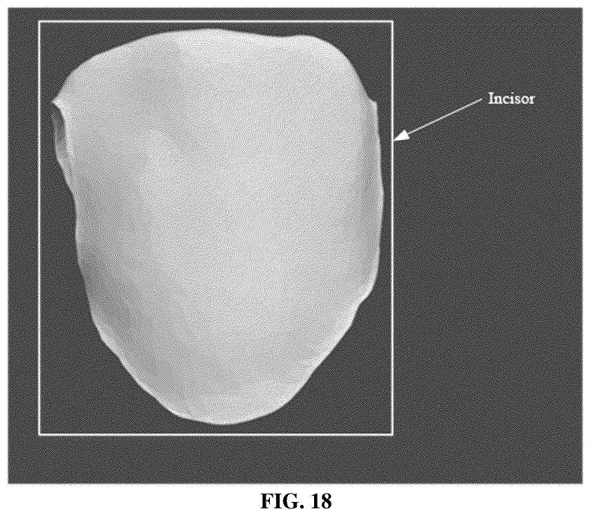

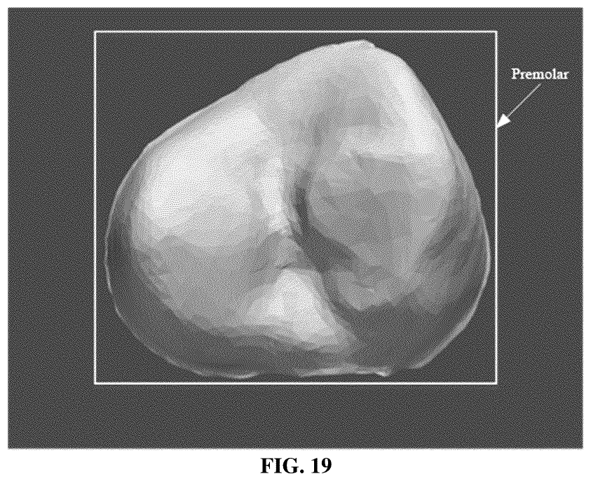

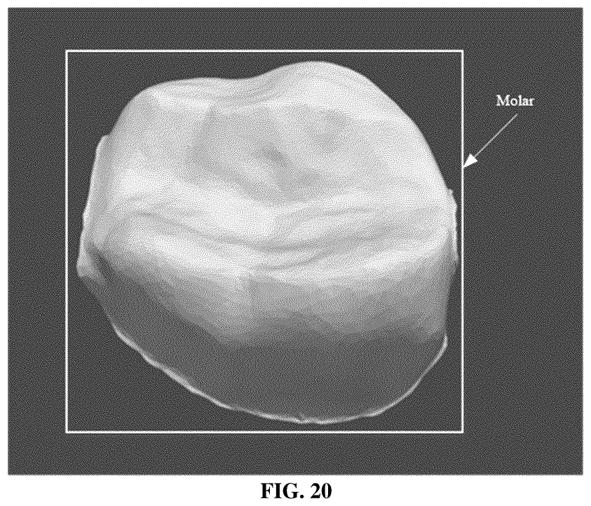

In an optional embodiment, the dental model is segmented to obtain at least one target area corresponding to a tooth. This can be achieved by a dental scanner segmenting at least one ROI area corresponding to a tooth from a 3D image of the dental model. The dental scanner needs to input the tooth number corresponding to at least one tooth, and the dental scanner can automatically output the ROI area corresponding to at least one tooth; For example, FIG. 17 is a schematic diagram of the target area corresponding to the upper incisor segmented according to an embodiment of the present invention. FIG. 17 shows the target area corresponding to the upper incisor segmented from the 3D stereoscopic image of the upper incisor in FIG. 13. FIG. 18 is a schematic diagram of the target area corresponding to the lower incisor segmented from the 3D stereoscopic image of the lower incisor in FIG. 14. FIG. 19 is a schematic diagram of the target area corresponding to the premolar segmented from the 3D stereoscopic image of the premolar in FIG. 15. FIG. 20 is a schematic diagram of the target area corresponding to a segmented molar according to an embodiment of the present invention. FIG. 20 shows the target area corresponding to the molar segmented from the 3D image of the molar in FIG. 16; By using the first deep learning model to predict the target area, the key points position can be obtained by inputting at least one ROI region corresponding to a tooth into the first deep learning model. The first deep learning model learns and infers the key points position corresponding to at least one tooth through multi-layer neural network learning on the input data, and represents them in the form of 3D position coordinates of the point.

In an optional embodiment, in response to the scanning type being an image scanning type, the oral scanner can further segment the 3D image of the upper incisor in FIG. 13 to obtain the target area corresponding to the upper incisor in FIG. 17; The oral scanner can further segment the 3D image of the lower incisor in FIG. 14 to obtain the target area corresponding to the lower incisor in FIG. 18; The oral scanner can further segment the 3D image of the premolar in FIG. 15 to obtain the target area corresponding to the premolar in FIG. 19; The oral scanner can further segment the 3D image of the molar in FIG. 16 to obtain the target area corresponding to the molar in FIG. 20. The obtained target areas for the upper incisor, lower incisor, premolar, and molars respectively facilitate the subsequent annotation of key points of the target tooth based on its tooth type.

Optionally, obtaining the tooth type of the at least one tooth in the tooth collection, including: determining a tooth type of the at least one tooth based on the tooth number of the at least one tooth.

The aforementioned tooth number is a system used to identify and name tooth, which may vary in different countries and regions. When using tooth numbers to determine key points position, taking the International Dental Numbering System as an example, each tooth has a specific tooth number. For the upper jaw, from the first right incisor (upper right incisor) to the third left molar (upper left molar), the corresponding tooth numbers are #1-#16; For the lower jaw, from the left first incisor (left lower first incisor) to the right third first molar (right lower third molar), the corresponding tooth numbers are #17-#32. By using the tooth number of the target tooth, the position information of the key points of the tooth in the dental model can be obtained based on the corresponding tooth characteristics and dental model, and represented in the form of 3D position coordinates of the points. It should be noted that different dental number systems may have different encoding rules and annotation methods.

In an optional embodiment, determining the tooth type of at least one tooth based on the tooth number of at least one tooth can be achieved through a corresponding tooth number system, which determines the tooth type of at least one tooth based on the encoding rules and labeling methods of the tooth number system. Taking the International Dental Number System as an example, the tooth type corresponding to tooth number #1 is the upper right first molar, and the tooth type corresponding to tooth number #24 is the lower left incisor. It should be noted that different dental number systems may have different encoding rules and annotation methods.

Optionally, predicting the key points of the dental model based on the scanning type to obtain the key points position of the dental model, including: obtaining a 3D mesh model of the dental model in response to the scanning type being a CT scanning type; segmenting the 3D mesh model to obtain a single dental model of the at least one tooth; predicting the single dental model of the at least one tooth by using the second deep learning model to obtain the key points position.

The aforementioned CT scanning type can be obtained through oral CT to obtain 3D images of the user's oral cavity. Among them, oral CT is an imaging examination method that generates 3D images of the oral cavity by using X-rays and computer technology. Oral CT usually requires patients to lie in a machine with a circular opening, which rotates around the head and performs X-ray scans. Oral CT can provide important information for the diagnosis and treatment of the oral cavity, and can help dentists make accurate diagnosis and treatment decisions.

The aforementioned single dental model can be a 3D model of a single tooth obtained through oral CT. It can provide accurate information on the shape, size, and position of tooth, which helps dentists diagnose, plan treatments, and simulate surgeries for tooth.

The aforementioned second deep learning model can be a machine learning model that uses multi-layer neural networks for learning and inference. The second deep learning model can be a semi supervised semantic segmentation network based on deep learning (MinkResUnet, also known as MinkUnet), which is based on neural networks and learns data representations through multiple levels of nonlinear transformations and feature extraction. It can effectively handle sparse and dense 3D point cloud data. The second deep learning model can also be other neural network models, which are not limited here. When the scanning type is oral CT, a second deep learning model can be used to predict the key points of the single dental model of at least one tooth in the user's mouth obtained from oral CT, and obtain the position of the key points.

In an optional embodiment, the 3D mesh model is segmented to obtain a single dental model of at least one tooth. This can be achieved by using an oral CT to segment the single dental model corresponding to at least one tooth from the 3D image of the dental model. It is necessary to input the tooth number corresponding to at least one tooth into the oral CT, and the oral CT can automatically output the single dental model corresponding to at least one tooth; Using a second deep learning model to predict the key points position of at least one single dental model. It can be obtained by inputting the user's oral 3D image obtained through oral CT and the tooth number of at least one target tooth into the second deep learning model. The second deep learning model will output the key points position information of at least one target tooth and represent it in the form of the 3D position coordinates of the point.

Optionally, marking the key points of the tooth collection in the dental model based on the scanning type and the key points position, including: determining the key points of the tooth collection as a maxillofacial center point and a root tip point in response to the scanning type being a CT scanning type; marking the maxillofacial center point and the root tip point in the dental model based on the key points position.

The aforementioned maxillofacial center point can refer to the center position of the tooth on the maxillofacial region (facing the oral cavity) of the upper and lower jaws. It is a position marker of tooth in the oral cavity, which helps dentists locate, measure, and plan treatment for tooth. The position of the center point of tooth in the maxillofacial region is related to different tooth and dental arches.

The aforementioned root tip point can refer to the most cutting-edge part of the tooth root. Each tooth has one or more apical points located at the tip of the tooth root. The root apex of a tooth is the end of the tooth that is in contact with surrounding tissues, including alveolar bone and alveolar mucosa.

In an optional embodiment, in response to the scanning type being a tomographic scanning type, the key points of the tooth collection are determined as the maxillofacial center point and the root apex point. That is, if the scanning type is using oral CT, the key points of the tooth collection are determined as the maxillofacial center point and the root apex point of the tooth; Annotating the maxillofacial center point and root apex point in the dental model based on the key points position can be achieved by using computer software or image editing tools. Based on the corresponding position of the maxillofacial center point and root apex point of at least one tooth in the oral CT single dental model, different colors can be used to mark the maxillofacial center point and points representing the axial direction and length of the tooth on the single dental model generated by oral CT through point drawing, achieving the annotation of key points of the tooth collection in the dental model.

Optionally, marking the key points of the tooth collection in the dental model based on the scanning type and the key points position, including: determining a key points type of the at least one tooth based on the tooth type of the at least one tooth in response to the scanning type being an image scanning type; marking the key points in the dental model based on the key points type and the key points position.

In an optional embodiment, in response to the scanning type being an image scanning type, the key points type of at least one tooth is determined based on the tooth type of at least one tooth. That is, if the scanning type is using an oral scanner, different types of tooth have different key points. Based on the key points type and key points position, key points are marked in the dental model, which can be done by using computer software or image editing tools. According to the key points type and its corresponding key points position of at least one tooth type, different colors can be used to mark the key points of the tooth set on the crown of the dental model through point drawing based on the target key points type.

### Embodiment 2

According to another aspect of the embodiments of the present invention, a device for generating a dental prosthesis model is also provided. This device is capable of executing the dental prosthesis model generation method described in the previous embodiment. The specific implementation method and preferred application scenarios are the same as those in the above embodiment, and thus will not be repeated here.

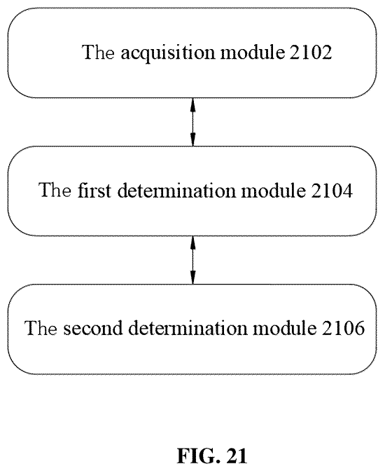

FIG. 21 is a schematic diagram of a dental prosthesis model generation device according to an embodiment of the present invention. As shown in FIG. 21, the device includes the following components: the acquisition module 2102, the first determination module 2104, and the second determination module 2106.

Among them, the acquisition module 2102 is used to obtain the restoration type for the tooth to be restored, where the restoration type includes at least one of the followings: dental implant type, crown restoration type, or inlay restoration type. The first determination module 2104 is used to determine the key points of the tooth to be restored based on the restoration type, where the key points represent the features of the tooth to be restored. The second determination module 2106 is used to determine the dental prosthesis model based on the restoration type and the key points of the tooth to be restored.

In the above embodiments of the present invention, the second determination module is further used to, in response to the restoration type being the dental implant type, obtain a 3D oral image of the target subject, where a dental implant is to be embedded in the oral cavity of the target subject. It segments the tooth from the 3D oral image to obtain the tooth position region of the missing tooth within the oral cavity. Based on the key points of the tooth to be restored, the key points of the dental implant are determined. The key points of the dental implant are then predicted based on the tooth position region, generating the dental prosthesis model, where the key points of the dental implant are used to determine the implant's orientation and size information.

In the above embodiments of the present invention, the second determination module is also used to construct a neural network model based on the 3D oral image to generate a 3D oral model. It utilizes an instance segmentation neural network model to perform tooth instance segmentation on the 3D oral model, thereby obtaining the tooth position region of the missing tooth within the oral cavity.

In the above embodiments of the present invention, the second determination module is further used to segment the 3D oral image into multiple image blocks. The sampling sub-unit is used to sample these image blocks to obtain a target feature map. The target feature map is then decoded to generate the 3D oral model.

In the above embodiments of the present invention, the second determination module is also used to downsample the multiple image blocks to obtain several first feature maps. These first feature maps are then upsampled to generate several second feature maps, where the scales of the second feature maps differ from those of the first feature maps, and the scales of the second feature maps also differ from each other. The second feature maps and the first feature maps are then merged to obtain the target features.

In the above embodiments of the present invention, the second determination module is also used to decode the target feature map to obtain an initial 3D oral model. The target region is then removed from the initial 3D oral model, and/or the disconnected neural conduits in the initial 3D oral model are reconstructed to obtain the 3D oral model, where the volume of the target region is less than a predetermined volume threshold.

In the above embodiments of the present invention, the second determination module is also used to employ an instance segmentation neural network model to perform tooth instance segmentation on the 3D oral model, thereby obtaining the dental model and the corresponding tooth number. Based on the dental model and tooth number, the 3D oral model is then trimmed to obtain the tooth position region.

In the above embodiments of the present invention, the second determination module is also used to employ an instance segmentation neural network model to perform tooth instance segmentation on the 3D oral model, thereby obtaining the dental model and the corresponding initial tooth numbers. In cases where the number of initial tooth numbers corresponding to the dental model is multiple, the tooth number with the highest quantity ratio among the initial tooth numbers is determined to be the tooth number.

In the above embodiments of the present invention, the second determination module is also used to determine the target tooth position in the 3D oral model based on the dental model and tooth number, where the target tooth position corresponds to the position of the missing tooth. At least one neighboring dental model is determined based on the target tooth position of the missing tooth. The 3D oral model is then trimmed based on the at least one neighboring dental model to obtain the tooth position region.

In the above embodiments of the present invention, the second determination module is also used to predict the key points of the dental implant within the tooth position region using a key points prediction neural network model, resulting in a key points heatmap. This heatmap represents the key points of the dental implant through a Gaussian distribution, where the key points include at least the implant insertion point and the implant apex point. Based on the key points heatmap, the implant's orientation and size information are determined. Using this orientation and size information, a model of the dental implant is then generated.

In the above embodiments of the present invention, the second determination module is also used to obtain multiple 2D oral images of the target subject. These multiple 2D oral images are then converted into a 3D oral image.

In the above embodiments of the present invention, the second determination module is also used to convert multiple 2D oral images into an initial 3D oral image. The multiple voxels in the initial 3D oral image are then resampled to have the same voxel spacing, resulting in the final 3D oral image.

In the above embodiments of the present invention, the second determination module is also used to resample the multiple voxels in the initial 3D oral model to the same voxel spacing, resulting in the target 3D oral image. The region of interest (ROI) within the target 3D oral image is then cropped to obtain the final 3D oral image, where the region of interest represents the area containing the target subject's tooth.

In the above embodiments of the present invention, the second determination module is further used to predict the key points of the dental implant based on the tooth position region, resulting in a prediction outcome. Based on this prediction result, a model of the dental implant is generated within the 3D oral model.

In the above embodiments of the present invention, the second determination module is also used to obtain the tooth number of the tooth to be restored and the outer contour of the area to be restored, where the tooth to be restored is the dental model to which the dental prosthesis model is to be added. The tooth number is used to indicate the position of the tooth to be restored within the dental model sequence, and the outer contour of the area to be restored represents the contour of part of the dental structure of the tooth to be restored. The determination module is further used to determine the preset dental prosthesis model corresponding to the tooth to be restored based on the tooth number, and to identify the key points of the tooth to be restored, where these key points represent the corresponding standard key points on a reference tooth. Additionally, the determination module is used to deform the preset dental prosthesis model based on the key points of the tooth to be restored and the outer contour of the area to be restored, thereby generating the dental prosthesis model.

In the above embodiments of the present invention, the second determination module is further used to determine the tooth number of the neighboring dental model based on the tooth number of the tooth to be restored. The neighboring dental model refers to the model of the tooth adjacent to the one being repaired, and the neighboring tooth number is used to indicate its position within the dental model sequence. The neighboring tooth point cloud data is determined based on the neighboring tooth number. The first adjustment unit is used to adjust the gap between the dental prosthesis model and the neighboring dental model based on the neighboring tooth point cloud data.

In the above embodiments of the present invention, the second determination module is also used to determine the opposing dental model corresponding to the tooth to be restored. The opposing dental model is the model of the tooth that has an occlusal relationship with the tooth to be restored. The fourth determination unit is used to determine the opposing tooth point cloud data based on the spatial positional relationship between the tooth to be restored and the opposing dental model. The second adjustment unit is used to adjust the occlusal relationship between the dental prosthesis model and the opposing tooth based on the opposing tooth point cloud data.

In the above embodiments of the present invention, the second determination module is also used to display multiple candidate dental models on the user interface in response to an input command applied to the interface. In response to a confirmation command applied to the interface, the system displays the selected tooth to be restored from the multiple candidate dental models on the interface.

In the above embodiments of the present invention, the second determination module is also used to identify the tooth to be restored by utilizing a deep learning model on the dental model sequence. The deep learning model is trained using sample dental model sequences and sample tooth to be restored.

In the above embodiments of the present invention, the second determination module is also used to perform instance segmentation on the dental model sequence using a tooth segmentation model, resulting in multiple dental models. The classification sub-unit is then used to classify these dental models using a tooth classification model, thereby identifying the tooth to be restored.

In the above embodiments of the present invention, the second determination module is also used to retrieve the preset dental prosthesis model corresponding to the tooth to be restored from a preset database based on the tooth number. The preset database contains preset dental prosthesis models corresponding to different tooth numbers.

In the above embodiments of the present invention, the second determination module is also used to determine the key points of the tooth to be restored based on the point cloud data of the tooth and the tooth number.

In the above embodiments of the present invention, the second determination module is also used to determine the key points of the tooth to be restored based on the point cloud data of the tooth to be restored, the tooth number, and the point cloud data of the neighboring tooth. Alternatively, the key points can be determined based on the point cloud data of the tooth to be restored, the tooth number, and the point cloud data of the opposing tooth. In another case, the key points can be determined based on the point cloud data of the tooth to be restored, the tooth number, the point cloud data of the neighboring tooth, and the point cloud data of the opposing tooth.

In the above embodiments of the present invention, the second determination module is also used to obtain the tooth data of the symmetrical dental model corresponding to the tooth to be restored. The symmetrical dental model represents the dental model that is symmetrically positioned in the same dental arch as the tooth to be restored. The key points of the tooth to be restored are then determined based on this tooth data.

In the above embodiments of the present invention, the second determination module is also used to obtain the dental model of tooth collection and the scanning type of the dental model. The dental model is obtained by scanning the tooth collection, which includes at least one tooth. The prediction module is further used to predict the key points of the dental model based on the scanning type, resulting in the key points locations of the dental model. Additionally, the labeling module is used to mark the key points of the tooth set in the dental model based on the scanning type and the key points locations.

In the above embodiments of the present invention, the second determination module is also used to respond to the scanning type being an image scanning type and to obtain the tooth type of at least one tooth in the tooth set. Based on the tooth type, at least one corresponding first deep learning model is invoked. This model is utilized to predict the key points of at least one tooth in the dental model, resulting in the key points locations.

In the above embodiments of the present invention, the second determination module is also used to segment the dental model to obtain the target region corresponding to at least one tooth. The first deep learning model is then utilized to predict within this target region, resulting in the key points locations.

In the above embodiments of the present invention, the second determination module is also used to determine the tooth type of at least one tooth based on the tooth number of that tooth.

In the above embodiments of the present invention, the second determination module is also used to respond to the scanning type being tomography (CT scan) by obtaining the 3D mesh model of the tooth. The 3D mesh model is segmented to obtain the single-dental model for at least one tooth. The second deep learning model is then utilized to predict the key points locations for the single-dental model.

In the above embodiments of the present invention, the second determination module is also used to respond to the scanning type being tomography (CT scan) by determining the key points of the tooth set as the occlusal center point and the apex point. Based on the key points locations, the occlusal center point and the apex point are marked in the dental model.

In the above embodiments of the present invention, the second determination module is also used to respond to the scanning type being an image scanning type by determining the key points types of at least one tooth based on the tooth type. The key points are then marked in the dental model based on the key points types and their corresponding locations.

### Embodiment 3

According to another aspect of the embodiments of the present invention, a computer-readable storage medium is also provided. The computer-readable storage medium includes a stored program, which, when executed, controls the processor of the device to perform the above-mentioned method for generating a dental prosthesis model.

### Embodiment 4

According to another aspect of the embodiments of the present invention, a medical system is also provided. The medical system includes: one or more processors; and a storage device configured to store one or more programs. When the one or more programs are executed by the one or more processors, they cause the processors to execute the above-mentioned method for generating a dental prosthesis model.

In the above embodiments of the present invention, the descriptions of the various embodiments each focus on specific aspects. Portions that are not detailed in a particular embodiment can be referred to in the relevant descriptions of other embodiments.

In the embodiments provided in The present invention, it should be understood that the disclosed technical content can be implemented in other ways. The device embodiments described above are merely illustrative. For example, the division of units can be a logical function division, and in actual implementation, other division methods may be used. For instance, multiple units or components may be combined or integrated into another system, or certain features may be omitted or not executed. Additionally, the coupling or direct coupling or communication connections shown or discussed may be indirect couplings or communication connections through interfaces, units, or modules, and these connections may be electrical or in other forms.

The components described as units for separation may or may not be physically distinct. The components displayed as units can also be either physical units or not, meaning they can be located in a single place or distributed across multiple units. Depending on actual needs, any part or all of the units can be selected to achieve the objectives of this embodiment.

Additionally, in various embodiments of the present invention, the functional units can be integrated into a single processing unit, exist separately as individual units, or have two or more units integrated into one. The integrated units can be implemented in the form of hardware or as software functional units.

If the integrated units are implemented as software functional units and sold or used as independent products, they can be stored on a computer-readable storage medium. Based on this understanding, the technical solution of the present invention, or the part of it that contributes to the prior art, or its entirety, can be embodied in the form of a software product. This computer software product is stored on a storage medium and includes several instructions that enable a computer device (which can be a personal computer, server, or network device, etc.) to execute all or part of the steps of the methods described in various embodiments of the present invention. The aforementioned storage media include: USB drives, Read-Only Memory (ROM), Random Access Memory (RAM), portable hard drives, magnetic disks, optical disks, and other media capable of storing program code.

The above description is merely a preferred embodiment of the present invention. It should be noted that, for those skilled in the art, several modifications and refinements can be made without departing from the principles of the present invention, and these modifications and refinements should also be considered within the scope of protection of the present invention.

What is claimed is:

1. A method for generating a restoration dental model, comprising:
obtaining a restoration type of a tooth to be restored, wherein the restoration type comprises at least one of the following: a dental implant type, a crown restoration type, and an inlay restoration type;
determining key points of the tooth to be restored based on the restoration type, wherein the key points of the tooth to be restored are configured to represent the characteristics of the tooth to be restored; and
determining the restoration dental model based on the restoration type and the key points of the tooth to be restored.

2. The method of claim 1, wherein determining the restoration dental model based on the restoration type and the key points, comprises:
obtaining a 3D oral image in response to the restoration type being the dental implant type;
performing a tooth instance segmentation on the 3D oral image to obtain a tooth position region of a missing tooth;
determining the key points of the dental implant based on the key points of the tooth to be restored; and
predicting the key points of the dental implant based on the tooth position region to obtain the restoration dental model, wherein the key points of the dental implant are configured to determine the implantation posture and size information of the dental implant.

3. The method of claim 2, wherein performing the tooth instance segmentation on the 3D oral image to obtain the tooth position region of the missing tooth in an oral cavity, comprises:
constructing a 3D oral model based on the 3D oral image by using a model construction neural network model; and
performing the dental instance segmentation on the 3D oral model by using an instance segmentation neural network model to obtain the tooth position region of the missing tooth in the oral cavity.

4. The method of claim 3, wherein constructing the 3D oral model based on the 3D oral image by using the model construction neural network model, comprises:
dividing the 3D oral image to obtain multiple image blocks;
sampling the multiple image blocks to obtain a target feature map; and
decoding the target feature map to obtain the 3D oral model.

5. The method of claim 4, wherein sampling the multiple image blocks to obtain the target feature map, comprises:
downsampling the multiple image blocks to obtain multiple first feature maps;
upsampling the multiple first feature maps to obtain multiple second feature maps, wherein the scales of the multiple second feature maps are different from the scales of the multiple first feature maps, and the scales between the multiple second feature maps are different; and
merging the multiple second feature maps and the multiple first feature maps to obtain the target feature map.

6. The method of claim 4, wherein decoding the target feature map to obtain the 3D oral model, comprises:
decoding the target feature map to obtain an initial 3D oral model; and
deleting a target area in the initial 3D oral model, and/or reconstructing the disconnected neural conduit in the initial 3D oral model to obtain the 3D oral model, wherein the volume of the target area is less than a preset volume threshold.

7. The method of claim 3, wherein performing the dental instance segmentation on the the 3D oral model by using the instance segmentation neural network model to obtain the tooth position region of the missing tooth in the oral cavity, comprises:
performing the dental instance segmentation on the 3D oral model by using the instance segmentation neural network model to obtain a dental model and a tooth number corresponding to the dental model; and
cropping the 3D oral model based on the dental model and the tooth number to obtain the tooth position region.

8. The method of claim 7, wherein performing the dental instance segmentation on the 3D oral model by using the instance neural network model to obtain the dental model and the tooth number corresponding to the dental model, comprises:
performing the dental instance segmentation on the 3D oral model by using the instance neural network model to obtain the dental model and an initial tooth number corresponding to the dental model; and
in the case wherein there are multiple initial tooth numbers corresponding to the dental model, determining the tooth number with the largest proportion among the initial tooth numbers as the tooth number.

9. The method of claim 7, wherein cropping the 3D oral model based on the dental model and the tooth number to obtain the tooth position region, comprises:
determining a target tooth position in the 3D oral model based on the dental model and the tooth number, wherein the target tooth position is a tooth position of the missing tooth;
determining at least one adjacent dental model of the missing tooth based on the target tooth position; and
cropping the 3D oral model based on the at least one adjacent dental model to obtain the tooth position region.

10. The method of claim 2, wherein predicting the key points of the dental implant based on the tooth position region to obtain a prediction result, comprises:
predicting the key points of the dental implant based on the tooth position region by using a key points prediction neural network model to obtain a key points heatmap, wherein the key points heatmap is configured to represent the key points of the dental implant by Gaussian distribution, and wherein the key points of the dental implant at least comprises the implant insertion point and the implant root tip point;
determining the implantation posture and the size information of the dental implant based on the key points heatmap; and
generating the restoration dental model based on the implantation posture and the size information.

11. The method of claim 2, wherein obtaining the 3D oral image of a target object, comprises:
obtaining multiple 2D oral images of the target object; and
performing 3D transformation on the multiple 2D oral images to obtain the 3D oral image.

12. The method of claim 11, wherein performing 3D transformation on the multiple 2D oral images to obtain the 3D oral image, comprises:
performing 3D transformation on the multiple 2D oral images to obtain an initial 3D oral image; and
resampling multiple voxels in the initial 3D oral image to the same voxel spacing to obtain the 3D oral image.

13. The method of claim 12, wherein resampling the multiple voxels in the initial 3D oral image to the same voxel spacing to obtain the 3D oral image, comprises:
resampling the multiple voxels in the initial 3D oral image to the same voxel spacing to obtain a target 3D oral image; and
cropping the interest region of the target 3D oral image to obtain a 3D oral image, wherein the interest region is configured to represent the area where the tooth of the target object are located.

14. The method of claim 2, wherein predicting the key points of the dental implant based on the tooth position region to obtain the restoration dental model, comprises:
predicting the key points of the dental implant based on the tooth position region to obtain a prediction result; and
generating the restoration dental model in the 3D oral model based on the prediction result.
